(19) United States
(12) Patent Application Publication
(10) Pub. No.: US 2026/0212447 A1
(43) Pub. Date: Jul. 23, 2026

(54) FRAME RESOLUTION SCALING WITH REGION BLURRING

(71) Applicant: Intel Corporation, Santa Clara, CA (US)

(72) Inventors: Sebastian Possos Medellin, Sammamish, WA (US); Yi Chu Wang, Santa Clara, CA (US); Yi-Jen Chiu, San Jose, CA (US); Syed Ahsan, Folsom, CA (US)

(73) Assignee: Intel Corporation, Santa Clara, CA (US)

(21) Appl. No.: 19/576,978

(22) Filed: Mar. 24, 2026

(51) Int. Cl. G06T 3/40; G06T 5/20; G06T 5/70; G06V 10/26; G06V 10/764

(52) U.S. Cl. CPC G06T 3/40; G06T 5/20; G06T 5/70; G06V 10/26; G06V 10/764

(57) ABSTRACT

An example system disclosed herein performs frame resolution scaling and region selective blurring in a single hardware filtering pass. A source image frame in RGBA format is supplied to the system. The alpha (A) channel of the RGBA format encodes a segmentation mask that distinguishes sharp and blur regions. For a given output pixel, the system evaluates the alpha values of the contributing source pixels, calculates a coverage metric, and classifies the output pixel as sharp, blurred, or transitional. Based on the classification, the system selects a corresponding filter coefficient set—sharp, hybrid blur, or hybrid transition—from memory. The selected coefficients drive a polyphase finite impulse response filter that simultaneously resamples and applies the appropriate blurring. The result is a scaled output frame that preserves detail in selected regions while blurring others without requiring separate filtering passes.

### BACKGROUND

Frame resolution scaling involves converting a source frame (which may be a video frame, image, picture, etc.) having a source resolution into an output frame having a different output resolution. The output resolution may be lower than the source resolution, such as when converting a source webcam frame to a lower resolution for transmission in an online meeting application, or higher than the source resolution, such as when converting a standard definition video frame to a high definition video frame for presentation by a media player application. Some frame resolution scaling techniques employ a resolution scaling filter having tap weights to combine pixels of the source frame to generate a corresponding pixel of the output frame.

### BRIEF DESCRIPTION OF THE DRAWINGS

FIG. 1 is a block diagram of an example compute device structured to perform frame resolution scaling with region blurring in accordance with teachings of this disclosure.

FIG. 2 illustrates an example frame resolution scaling operation.

FIG. 3 illustrates an example region blurring operation.

FIG. 4 illustrates an example blur-enabled frame resolution scaling process implemented by the example compute device of FIG. 1.

FIG. 5 is a block diagram of an example implementation of blur-enabled resolution scaling circuitry included in the example compute device of FIG. 1 to perform frame resolution scaling with region blurring in accordance with teachings of this disclosure.

FIGS. 6-9 are flowcharts representative of example machine-readable instructions and/or example operations that may be executed, instantiated, and/or performed by example programmable circuitry to implement the blur-enabled resolution scaling circuitry of FIG. 5.

FIG. 10 is a block diagram of an example processing platform including programmable circuitry structured to execute, instantiate, and/or perform the example machine-readable instructions and/or perform the example operations of FIGS. 6-9 to implement the blur-enabled resolution scaling circuitry of FIG. 5.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine-readable instructions of FIGS. 6-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Compute devices, such as personal computers, notebook computers, tablet computers, smartphones, etc., routinely provide frame resolution scaling capability to convert source frames having a source resolution into corresponding output frames having an output resolution that differs from the source resolution. As used herein, a frame can refer to a video frame, an image or an image frame, a digital picture, etc. A resolution scaling filter may be used to combine pixels, also referred to as samples, of the source frame to generate a corresponding pixel, or sample, of the output frame. Some resolution scaling filters are finite impulse response (FIR) filters having filter coefficients (also referred to as filter tap weights, taps, weights, etc.) to multiply the source pixels of the source frame. Such an FIR resolution scaling filter further accumulates the resulting scaled source pixels to produce the output pixel of the output frame. Additionally or alternatively, some resolution scaling filters have a polyphase structure that divides the source pixels into different sub-pixels or phases, such that different filter coefficients or tap weights can be used based on how the output pixels to be generated align spatially with the respective groups or sets of source pixels to be combined by the resolution scaling filter to generate those output pixels.

To support frame resolution scaling in real-time, compute devices may implement a hardware-based resolution scaling filter to enable resolution scaling of frames to be performed at a video frame rate, such as 30 frames per second (fps), 60 fps, etc. However, conventional hardware-based resolution scaling filters employ a fixed configuration across all output pixels to be generated for a given output frame. For example, conventional polyphase FIR scaling filters employ predetermined, phase-indexed FIR coefficient sets that remain static across all output pixels of a given output frame. Moreover, conventional polyphase FIR scaling filters do not incorporate alpha channel information of the pixel data, or other local contextual information, such as segmentation masks, into the resolution scaling process. Because conventional resolution scaling filters cannot be modified on a per-pixel basis, such filters are restricted to a single resolution scaling filter response for the entire output image. As a result, conventional resolution scaling filters are unable to apply spatially varying operations, such as selective blur, obfuscation, background suppression, etc., within the same execution pass as the resolution scaling operation.

Thus, to achieve such region-dependent privacy effects, compute devices employing conventional resolution scaling filters resort to multi-pass processing or separate filtering stages to perform a combination of frame resolution scaling and selective region blurring. For example, some compute devices employing conventional resolution scaling filters may implement a multi-pass approach in which frame resolution scaling is performed in a first execution pass, then followed by selective region blurring being performed in a subsequent second execution pass with a dedicated blur engine or shader that operates independently of the conventional resolution scaling filter. Such multi-pass processing can result in the need for additional intermediate buffers, increased compute demand, higher memory bandwidth usage, and/or greater overall latency.

In contrast, example frame resolution scaling techniques disclosed herein employ blur-enabled resolution scaling circuitry that combines selective region blurring with frame resolution scaling in a single processing pass. As disclosed in further detail below, example blur-enabled resolution scaling circuitry disclosed herein provides a per-pixel, alpha-driven tap selection mechanism that enables region selective blurring to be integrated into the same hardware-based FIR filter used for frame resolution scaling. Many modern compute devices support the red-green-blue-alpha (RGBA) channel format for representing frame pixel data. The alpha channel of the RGBA format represents the transparency or opacity of the respective pixels of the frame. Applications can set the alpha channel values of pixels in a frame to specify one or more region(s) of interest in the frame. For example, an application can set the alpha channel values of the pixels included in a region of interest (e.g., such as a foreground region) to a first value (e.g., a value of 1) and the alpha channel values of other pixels not included in the region of interest (e.g., such as a background region) to a different second value (e.g., a value of 0), or vice versa. Some frame segmentation techniques set the alpha channel values of a frame to values in a range of 0 to 1 representative of the probability a given pixel is included in a region of interest.

In some examples, for a given output pixel to be generated, example blur-enabled resolution scaling circuitry disclosed herein computes a region classification for the output pixel based on the alpha channel values of the source pixels to be used to generate that output pixel. For example, the region classification can specify whether the output pixel is associated with a sharp region that is to remain sharp in the output frame, or a blur region that is to be blurred in the output frame. In some examples, the region classification can specify whether the output pixel is associated with a transition region between a sharp region and a blur region. For example, in the context of a video conferencing application, the sharp region may correspond to the foreground region of the frame, the blur region may correspond to the background region of the frame, and the transition region may correspond to a region between the foreground and background regions. As another example, in the context of a privacy-enabled application, the blur region may correspond to a detected facial region in the frame, the sharp region may correspond to the region of the frame not including the detected facial region, and the transition region may correspond to a region between the foreground and background regions.

Example blur-enabled resolution scaling circuitry disclosed herein uses the region classification for a given output pixel to dynamically select between two or more filter coefficient sets, or filter tap sets, to be used by the resolution scaling filter to combine selected source pixels of the source frame to generate that output pixel of the output frame. For example, the available filter coefficient sets may include a sharp coefficient filter set that defines a sharp resolution scaling filter that performs resolution scaling without employing region-specific blurring, and a blur coefficient set that defines a blur resolution scaling filter that performs region-specific blurring along with resolution scaling. In some examples, for a given output pixel, the blur-enabled resolution scaling circuitry selects between the sharp resolution scaling filter or the blur resolution scaling filter based on whether the region classification for the given output pixel specifies that the output pixel corresponds to (e.g., belongs to, is included in, etc.) a sharp region or a blur region. In some examples, the available filter coefficient sets further include a transition coefficient filter set that defines a transition resolution scaling filter that performs resolution scaling region along with weaker, or lighter, blurring than performed by the blur resolution scaling filter. In some examples, for a given output pixel, the blur-enabled resolution scaling circuitry selects between the sharp resolution scaling filter, the blur resolution scaling filter or the transition resolution scaling filter based on whether the region classification for the given output pixel specifies the output pixel corresponds to (e.g., belongs to, is included in, etc.) a sharp region, a blur region or a transition region.

In some examples, based on the filter selection for the given output pixel, the blur-enabled resolution scaling circuitry programs or otherwise configures a hardware-based filter to access the coefficients (e.g., taps) associated with the selected filter. For example, the hardware-based filter may implement an N-tap FIR filter (e.g., with N=4, 8, 16, etc.) having N filter coefficients that define a separable FIR filter that processes a group of N² source pixels in the horizontal direction and then in the vertical direction (or vice versa) to produce an output pixel from that group of N² source pixels. In some such examples, the sharp resolution scaling filter, the blur resolution scaling filter and the transition resolution scaling filter are defined by respective different sets of N coefficients (or taps), which are stored in different registers and/or memory locations each indexed by a respective base address. In such examples, the blur-enabled resolution scaling circuitry programs or otherwise configures a hardware-based filter with the particular base address corresponding to the resolution scaling filter selected based on the output pixel's region classification, which can be changed on a pixel-by-pixel basis with little to no additional processing overhead, and which causes the filter circuitry to access the appropriate filter coefficients to be used to generate the current output pixel.

Because the same resolution scaling filter structure is used to perform both resolution scaling and region-specific blurring, example blur-enabled resolution scaling circuitry disclosed herein eliminates the need for separate resolution scaling and blur processing passes, thereby delivering memory bandwidth and power consumption savings relative to conventional privacy-enabled video pipelines, and enabling real-time background obfuscation at any resolution without performance degradation. As such, example blur-enabled resolution scaling circuitry disclosed herein can enhance consumer applications (e.g., video conferencing, screen sharing, livestreaming, etc.) and enterprise environments (e.g., telepresence systems, secure collaboration platforms, privacy-compliant surveillance, etc.), in which background blur and/or other privacy-related frame obfuscation is offered.

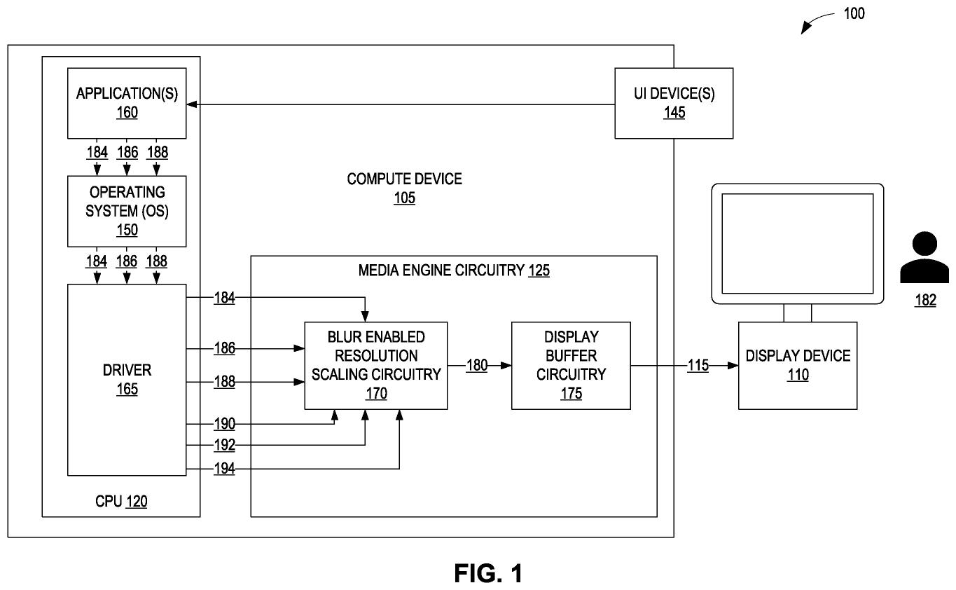

FIG. 1 is a block diagram of an example compute system 100 including example compute device 105 structured to perform frame resolution scaling with region blurring in accordance with teachings of this disclosure. The compute system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the compute system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example compute system 100 of FIG. 1 may be any type of compute system capable of generating and displaying image and/or video data. For example, the compute system 100 may be a personal computer, a notebook computer, a server, a smartphone, a media device, etc. The compute system 100 includes the example compute device 105 and an example display device 110. The compute device 105 of the illustrated example can be any type of compute device capable of generating or otherwise providing image and/or video data to be displayed. For example, the compute device 105 may be a CPU, a GPU, a system board (e.g., a motherboard), a personal computer, a notebook computer, a server, a smartphone, a media device, etc. The display device 110 of the illustrated example may be any type of display device capable of displaying image and/or video data. For example, the display device 110 may be a computer monitor, a television, a touchscreen display, etc. In some examples, the compute device 105 and the display device 110 are separate devices (e.g., with separate housings, chassis, etc.). In some examples, the compute device 105 and the display device 110 are integrated into the compute system 100 (e.g., included in a same housing, chassis, etc.).

In the illustrated example system 100 of FIG. 1, the compute device 105 generates pixel data corresponding to a frame (e.g., a video frame, an image or an image frame, a digital picture, etc.) to be displayed by the display device 110, and sends the pixel data to the display device 110 via an example interface 115. The interface 115 of the illustrated example can be any type of interface capable of sending (e.g., transmitting) pixel data from the compute device 105 to the display device 110. For example, the interface 115 may be High-Definition Multimedia Interface (HDMI), DisplayPort (DP), Digital Visual Interface (DVI), Video Graphics Array (VGA), Universal Serial Bus (USB), etc., and/or any other wired and/or wireless interface, and/or combination thereof.

The compute device 105 of the illustrated example includes example central processing unit (CPU) circuitry 120, example media engine circuitry 125, and one or more example user interface devices 145. The CPU 120 of the illustrated example includes (e.g., executes) an example operating system (OS) 150, one or more example applications 160 and an example driver 165 to interface between the CPU 120 and the media engine circuitry 125. The media engine circuitry 125 of the illustrated example includes example blur-enabled resolution scaling circuitry 170 to perform frame resolution scaling with region blurring in accordance with teachings of this disclosure. The media engine circuitry 125 of the illustrated example further includes example display buffer circuitry 175 to implement a display buffer to store output frames 180 (e.g., output video frames, output images or image frames, output digital pictures, etc.) from the blur-enabled resolution scaling circuitry 170 and which are to be provided (e.g., sent, transmitted, etc.) to the display device 110 via the interface 115.

In the illustrated example, the user interface device(s) 145 of the compute device 105 include one or more of a mouse, a keyboard, a stylus, a touchscreen, etc., to allow an example user 182 of the compute device 105 to enter user input data to be processed by the compute device 105, such as user input data to be processed by one or more of the applications 160 executed by the compute device 105. In some examples, the user interface device(s) 145 also include a camera to capture image data, video data, etc., in the environment of the compute device 105. Such a camera may be integrated into the compute device 105 (e.g., such as an integrated camera) or separate from but coupled to the compute device 105 (e.g., such as a separate camera accessory). In some examples, the camera of the user interface device(s) 145 is positionable to capture camera data including images and/or video of the environment, which may include capturing images and/or video of the user 182.

The application(s) 160 include any application capable of generating or otherwise providing example source frames 184 (e.g., source video frames, source images or image frames, source digital pictures, etc.) for presentation by the display device 110. For example, the application(s) 160 may include one or more video conferencing applications, one or more online meeting applications, one or more streaming media applications, etc. In the illustrated example, an active application 160 of the application(s) 160 that is providing the source frames 184 also provides example source resolution data 186 that specifies a resolution (e.g., a frame size, a pixel density, etc.) of the source frames 184 being output from the active application 160. For example, the source resolution data 186 may be determined by the application 160 based on one or more characteristics of the camera of the user interface devices 145 that is capturing and generating the source frames 184, based on one or more streaming parameters associated with the source frames 184 being streamed from a streaming server, etc. The active application 160 of the illustrated example further provides example output resolution data 188 that specifies a resolution (e.g., a frame size, a pixel density, etc.) of the output frames 180 (e.g., output video frames, output image frames, etc.) to be provided to the display device. In some examples, the output resolution data 188 is determined by the application 160 based on user input data provided by the user 182 via the user interface devices 145. For example, the user 182 may use the user interface devices 145 to resize a window displaying the source frames 184, and the application 160 may use the dimensions of the resized window to compute the output resolution of the output frames 180. As another example, the application 160 may determine the output resolution data 188 based on a user selection provided via the user interface device(s) 145 (e.g., specifying the source frames 140 have a standard definition resolution and are to be converted to a high definition resolution) and/or based on characteristics of the display device 110 (e.g., which may support a different output resolution than the resolution of the source frames 140).

The active application 160 of the illustrated example also supports specification of one or more regions in the source frames 184 that is (are) to be blurred in the output frames 180, as well as one or more regions in the source frames 184 that is (are) to remain sharp (e.g., unblurred and/or in their original quality) in the output frames 180. As such, the active application 160 can implement or otherwise access any past, present or future frame segmentation algorithm(s) to segment source frames 184 into sharp region(s) and blur region(s). Examples of background segmentation algorithms include machine learning (ML) algorithms that are trained to detect one or more objects that correspond to the foreground region(s) of the frame, ML algorithms that are trained to detect one or more static (or semi-static) regions that correspond to the background region of the frame, etc. Furthermore, the active application 160 can identify whether a particular segmented region of a source frame 184 identified by the frame segmentation algorithm(s) corresponds to a blur region that is to undergo selective region blurring during generation of the corresponding output frame 180, or a sharp region that is to remain sharp (e.g., not undergo selective region blurring) in the output frame 180. For example, the active application 160 can base such segmented region identification on user input data provided by the user 182 via the user interface device(s) 145. For example, in the context of a video conferencing application 160, the user input data may specify that a segmented background region of the source frame 184 corresponds to a blur region, and a remaining segmented foreground region of the source frame 184 corresponds to a sharp region. As another example, in the context of a privacy-enabled application, the user input data may specify that a segmented facial region of the source frame 184 (e.g., which contains a face detected by the frame segmentation algorithm(s)) corresponds to a blur region, and a remaining non-facial region of the source frame 184 corresponds to a sharp region.

In some examples, the active application 160 can utilize any past, present or future frame segmentation algorithm(s) to assign respective segmentation values to the corresponding source pixels of a source frame 184 to indicate whether a given source pixel is included in a sharp region of the source frame 184 or a blur region of the source frame 184.

In some examples, the frame segmentation algorithm(s) utilized by the application 160 use a segmentation value having a first value (e.g., a value of 1) to identify pixels in the sharp region, and a different second value (e.g., a value of 0) to identify pixels in the blur region. In some examples, the frame segmentation algorithm(s) utilized by the application 160 use values in a range of 0 to 1 to represent the probability of a given pixel being included in the sharp version vs. the blur region (e.g., with values closer to 1 indicating the pixel is likely in the sharp region, and with values closer to 0 indicating the pixel is likely in the sharp region, or vice versa). In some examples, the application 160 allows the user to specify a region of the source frames 184 that is to be blurred (e.g., such as a background region of a video stream in a video conferencing application, a foreground facial region of a video stream in a privacy-enabled application, etc.) and the application 160 automatically determines that the source pixels of the source frames 184 that are not included in the specified blurred region are to be included in a region of interest corresponding to the sharp region of the source frames 184.

In the illustrated example, the active application 160 packs the source pixel data of the source frames 184 in an RGBA format such that each source pixel of a source frame 184 includes three (3) color channels (also referred to as components) containing red (R), green (G) and blue (B) color values, respectively, and one (1) alpha (A) channel (or component) containing an alpha value for the source pixel. However, in some examples, the source pixel data of the source frames 184 can be packed into other formats, such as a format with three (3) color channels corresponding to luminance (Y) and chrominance (U and V) color values, and one (1) alpha (A) channel containing the alpha value for the source pixel. In either format, the alpha channel represents the transparency or opacity of the respective source pixels of the source frame 184. In the illustrated example, the active application 160 sets the alpha channel values of the source pixels in a source frame 184 to their respective segmentation values to assign the pixels to the sharp and blur regions of the source frame.

In some examples, the source pixels of the source frames 184 are formatted to have a size (e.g., bit length, bit resolution, number of bits, etc.) of eight (8) bits such that each component of a pixel is represented by an 8-bit value, such as an 8-bit alpha (A) value, an 8-bit red (R) color value, an 8-bit green (G) color value and an 8-bit blue (B) color value, resulting in the RGBA value of the pixel being represented by 4×8=32 bits. In some examples, source pixels of the source frames 184 are formatted to have a size in which the different channels of a given pixel are represented by more or fewer bits, and with some or all of the different channels having the same or different numbers of bits.

In the illustrated example, the active application 160 provides the RGBA-formatted source pixels of the source frames 184, the source resolution data 186 and the output resolution data 188 to the driver 165 via the OS 150 (e.g., via one or more OS system calls, library calls, etc.). The driver 165 provides the RGBA-formatted source pixels of the source frames 184, the source resolution data 186 and the output resolution data 188 to the media engine circuitry 125, which processes the source frames 184, the source resolution data 186 and the output resolution data 188 to generate the output frames 180 to be buffered in the display buffer circuitry 175 and ultimately displayed by the display device 110. The driver 165 of the illustrated example also provides additional data to the media engine circuitry 125 to be used by the blur-enabled resolution scaling circuitry 170. For example, such data includes example sharp resolution scaling filter coefficient set 190, an example blur filter kernel 192, and example configuration data 194. Example uses of the sharp resolution scaling filter coefficient set 190, the blur filter kernel 192, and the configuration data 194 by the blur-enabled resolution scaling circuitry 170 are described in detail below.

The blur-enabled resolution scaling circuitry 170 of the illustrated example employs a polyphase FIR filter structure to combine groups of N×N=N² source pixels of a source frame 184 to generate a corresponding output pixel of an output frame 180 such that the source frame 184 and the output frame 180 have different resolutions. In some examples, the polyphase FIR filter structure of the blur-enabled resolution scaling circuitry 170 is a separable filter structure that processes groups of N source pixels in the horizontal direction and then processes groups of N source pixels in the vertical direction (or vice versa) to produce an output pixel from the group of N×N=N² source pixels. For example, the polyphase FIR filter structure of the blur-enabled resolution scaling circuitry 170 can compute a weighted sum of N source pixels in the horizontal or vertical directions according to Equation 1, which is:

$$Out = {\sum }_{k = 0}^{N - I} {f}_{φ} [ k ] \cdot Src [ k ] \qquad Equation 1$$

In Equation 1, Src[k] represents the source pixels of the source frame 184 that are selected to produce the corresponding output pixel Out of the output frame 180. In Equation 1, f_{φ}[k] represents the filter coefficient set (e.g., also referred to as the set of filter coefficients, a set of filter taps, a filter tap set, set of tap weights, a tap weight set, etc.) selected to program the polyphase FIR filter structure to combine a group of source pixels Src[k] to produce the corresponding output pixel Out. In the illustrated example, the filter coefficient set includes phase-dependent coefficients in which o represents the sub-pixel phase selected based on the spatial alignment of the output pixel Out relative to the group of source pixels Src[k]. In Equation 1, N represents the size (e.g., the tap count) of the filter coefficient set f_{φ}[k], which corresponds to the horizontal and vertical dimensions of the group of source pixels Src[k] selected to produce the corresponding output pixel Out. For example, the tap count N can be 4, 6, 8, 12, 16, etc.

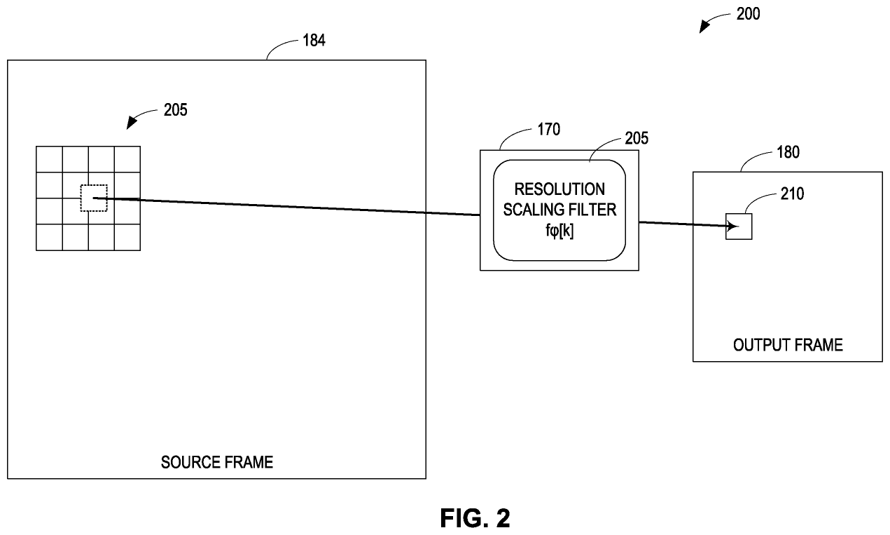

FIG. 2 illustrates an example frame resolution scaling operation 200 that can be performed by the blur-enabled resolution scaling circuitry 170 using an example resolution scaling filter 205 implemented according to the polyphase FIR filter structure of Equation 1. In the example frame resolution scaling operation of 200 of FIG. 2, the blur-enabled resolution scaling circuitry 170 selects, using any appropriate technique, an example group, or set, of source pixels 210 of the source frame 184 to be used to generate a corresponding example output pixel 215 of the output frame 180 based on the source resolution data 186, the output resolution data 188 and the tap size N of the resolution scaling filter 205. Thus, the source pixels 210 correspond to Src[k] of Equation 1, the output pixel 215 corresponds to Out of Equation 1, and the resolution scaling filter 205 implements the polyphase FIR filter structure with the selected coefficient set f_{φ}[k] of Equation 1. In some examples, the tap size N of the resolution scaling filter 205 is specified in the configuration data 194 provided by the driver 165 to the blur-enabled resolution scaling circuitry 170.

As illustrated in the example of FIG. 2, the output pixel 215 may not align spatially with the center of the source pixels 210. As such, the resolution scaling filter 205 employs the polyphase FIR filter structure of Equation 1 in which the selected coefficient set f_{φ}[k] is phase-dependent. In the illustrated example, the blur-enabled resolution scaling circuitry 170 selects, using any appropriate technique, the sub-pixel phase φ from a set of possible phases such that the resulting selected coefficient set f_{φ}[k] weights the source pixels 210 to account for their spatial alignment with the output pixel 215.

Returning to FIG. 1, and with reference to FIG. 2, the blur-enabled resolution scaling circuitry 170 selects from among multiple available filter coefficient sets to program the resolution scaling filter 205 based on the polyphase FIR filter structure of Equation 1. In some examples, the available filter coefficient sets include the sharp resolution scaling filter coefficient set 190 provided by the driver 165, which performs resolution scaling without region-specific blurring, and a blur resolution scaling filter coefficient set generated by the blur-enabled resolution scaling circuitry 170 based on the blur filter kernel 192 provided by the driver 165. In some examples, the available filter coefficient sets include the sharp resolution scaling filter coefficient set 190 provided by the driver 165, which performs resolution scaling without region-specific blurring, a blur resolution scaling filter coefficient set generated by the blur-enabled resolution scaling circuitry 170 based on the blur filter kernel 192 provided by the driver 165, and a transition resolution scaling filter coefficient set generated by the blur-enabled resolution scaling circuitry 170 based on a transition filter kernel provided by the driver 165 in the configuration data 194. For example, the driver 165 may access the sharp resolution scaling filter coefficient set 190, the blur filter kernel 192 and/or the configuration data 194 from system memory, user input data, etc., during system startup and/or any other initialization procedure and provide that data, and/or pointer(s) to that data, to the blur-enabled resolution scaling circuitry 170 to initialize frame resolution scaling in the compute device 105.

In some examples, the blur-enabled resolution scaling circuitry 170 can program the filter coefficient set f_{φ}[k] of the resolution scaling FIR filter structure of Equation 1 with the sharp resolution scaling filter coefficient set 190, represented by A_{φ}[k], directly (e.g., without modification). As such, the sharp resolution scaling filter coefficient set 190, A_{φ}[k], has a tap count of N, in accordance with Equation 1. In some examples, the blur filter kernel 192, represented by B[k], has the same number of taps, N, as the sharp resolution scaling filter coefficient set 190, and the blur-enabled resolution scaling circuitry 170 generates a blur resolution scaling filter coefficient set based on a combination of the sharp resolution scaling filter coefficient set 190 and the blur filter kernel 192. For example, the blur-enabled resolution scaling circuitry 170 may generate a blur resolution scaling filter coefficient set, represented by H_{φ}[k], based on the sharp resolution scaling filter coefficient set 190, A_{φ}[k], and the blur filter kernel 192, represented by B[k], according to Equation 2, which is:

$${H}_{φ} [ k ] = F \{ {A}_{φ} [ k ] , B [ k ] \} \qquad Equation 2$$

In Equation 2, the function F { } represents a fusion operation used to combine the sharp resolution scaling filter coefficient set 190, A_{φ}[k], and the blur filter kernel 192, represented by B[k], to produce a hybrid filter H_{φ}[k]. As a result, the filter H_{φ}[k] is also referred to as a hybrid blur resolution scaling filter. In some examples, the blur-enabled resolution scaling circuitry 170 employs a similar hybrid fusion operation to generate a transition resolution scaling filter coefficient set, represented by H₂_{_{φ}}[k], based on a combination of the sharp resolution scaling filter coefficient set 190 and a transition filter kernel included in the configuration data 194.

In the illustrated example, the blur-enabled resolution scaling circuitry 170 selects which filter coefficient set to program the resolution scaling filter 205 based on a per-pixel region classification of the output pixel 215. In some examples, for a given output pixel 215 to be generated, the blur-enabled resolution scaling circuitry 170 computes a region classification for the output pixel 215 based on the alpha channel values of the source pixels 210 to be used to generate that output pixel 215. For example, the region classification can specify whether the output pixel 215 is associated with a sharp region that is to remain sharp in the output frame 180, or a blur region that is to be blurred in the output frame 180. In some examples, the region classification can specify whether the output pixel 215 is associated with a transition region between a sharp region and a blur region of the output frame 180. For example, in the context of a video conferencing application, the sharp region may correspond to the foreground region of the frame, the blur region may correspond to the background region of the frame, and the transition region may correspond to a region between the foreground and background regions. As another example, in the context of a privacy-enabled application, the blur region may correspond to a detected facial region in the frame, the sharp region may correspond to the region of the frame not including the detected facial region, and the transition region may correspond to a region between the foreground and background regions.

In the illustrated example, the blur-enabled resolution scaling circuitry 170 uses the region classification for a given output pixel 215 to dynamically select between two or more filter coefficient sets, or filter tap sets, to be used by the resolution scaling filter 205 to combine the selected source pixels 210 of the source frame 184 to generate the given output pixel 215 of the output frame 180. For example, the available filter coefficient sets may include the sharp coefficient filter set 190 that defines the sharp resolution scaling filter A_{φ}[k] that performs resolution scaling without employing region-specific blurring, and the hybrid blur coefficient set that defines the hybrid blur resolution scaling filter H_{φ}[k] that performs region-specific blurring along with resolution scaling. In some examples, for a given output pixel 215, the blur-enabled resolution scaling circuitry 170 selects between the sharp resolution scaling filter A_{φ}[k] or the hybrid blur resolution scaling filter H_{φ}[k] based on whether the region classification for the given output pixel 215 specifies the output pixel corresponds to (e.g., belongs to, is included in, etc.) a sharp region or a blur region. In some examples, the available filter coefficient sets further include the hybrid transition coefficient filter set that defines a transition resolution scaling filter H₂_{_{φ}}[k] that performs resolution scaling region along with weaker, or lighter, blurring than performed by the blur resolution scaling filter H_{φ}[k]. In some examples, for a given output pixel 215, the blur-enabled resolution scaling circuitry 170 selects among the sharp resolution scaling filter A_{φ}[k], the blur resolution scaling filter H_{φ}[k] or the transition resolution scaling filter H₂_{_{φ}}[k] based on whether the region classification for the given output pixel 215 specifies the output pixel 215 corresponds to (e.g., belongs to, is included in, etc.) a sharp region, a blur region or a transition region.

In the illustrated example, based on the filter selection for the given output pixel 215, the blur-enabled resolution scaling circuitry 170 programs or otherwise configures a hardware-based filter to access the coefficients (e.g., taps) associated with the selected filter. For example, the hardware-based filter may implement the N-tap FIR filter with filter taps f_{φ}[k] of Equation 1. As described above, the filter taps f_{φ}[k] of Equation 1 correspond to N filter coefficients that define a separable FIR filter that processes a group of N² source pixels 210 in the horizontal direction and then in the vertical direction (or vice versa) to produce the output pixel 215 from that group of N² source pixels 210. In some such examples, the respective different sets of N coefficients (or taps) for the sharp resolution scaling filter A_{φ}[k], the hybrid blur resolution scaling filter H_{φ}[k] and the hybrid transition resolution scaling filter H₂_{_{φ}}[k] are stored in different registers and/or memory locations each indexed by a respective base address. In such examples, the blur-enabled resolution scaling circuitry 170 programs or otherwise configures the hardware-based filter of Equation 1 to read the filter taps f_{φ}[k] from the particular base address corresponding to the resolution scaling filter selected based on the output pixel's region classification, which can be changed on a pixel-by-pixel basis with little to no additional processing overhead, and which causes the filter circuitry to access the appropriate filter coefficients to be used to generate the current output pixel 215 of the output frame 180.

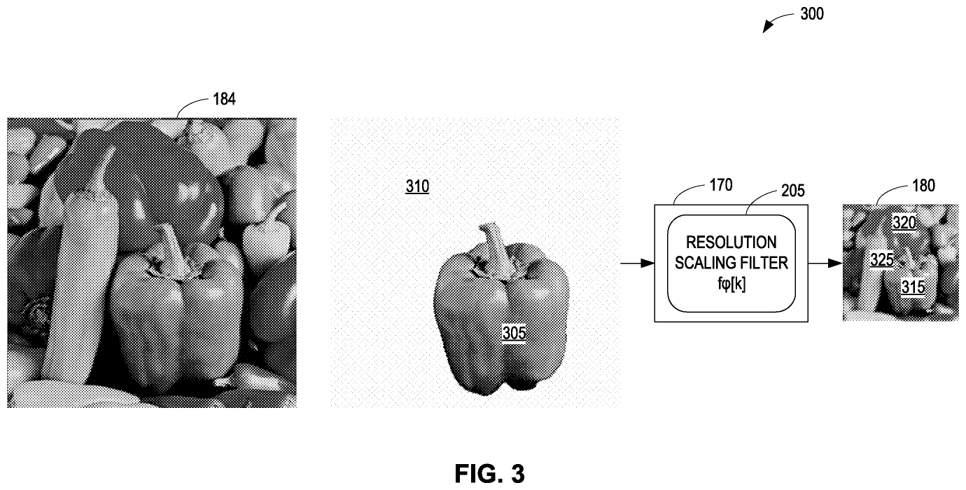

FIG. 3 illustrates an example frame resolution scaling with region blurring operation 300 performed by the blur-enabled resolution scaling circuitry 170 with the resolution scaling filter 205. In the illustrated example of FIG. 3, the active application 160 generates an example source frame 184. The active application 160 also encodes the alpha channel values of the source pixels of the source frame 184 with segmentation values that define an example sharp region 305 corresponding to a foreground object in the source frame 184, and an example blur region 310 corresponding to a remaining background region of the source frame 184. In the example operation 300 of FIG. 3, the blur-enabled resolution scaling circuitry 170 uses the alpha channel segmentation values of the source pixels of the source frame 184 as described above and in further detail below to classify the output pixels of the output frame 180 as belonging to a sharp region corresponding to the sharp region 305, an output blur region corresponding to the blur region 310, or a transition region of the output frame 180 corresponding to a region of transition between the sharp region 305 and the blur region 310. In the example operation 300, the blur-enabled resolution scaling circuitry 170 further selects, for a given output pixel on a pixel-by-pixel basis, one of the sharp resolution scaling filter A_{φ}[k], the blur resolution scaling filter H_{φ}[k] or the transition resolution scaling filter H₂_{_{φ}}[k] to be used by the resolution scaling filter 205 to generate that output pixel, with the selection based on the region classification of that output pixel. The result is the example output frame 180 of FIG. 3 that has undergone resolution scaling and selective region blurring to yield an example output sharp region 315 corresponding to the sharp region 305 of the source frame 184, an example output blur region 320 corresponding to the blur region 310 of the source frame 184, and an example output transition region 325 between the output sharp region 315 and the output blur region 320.

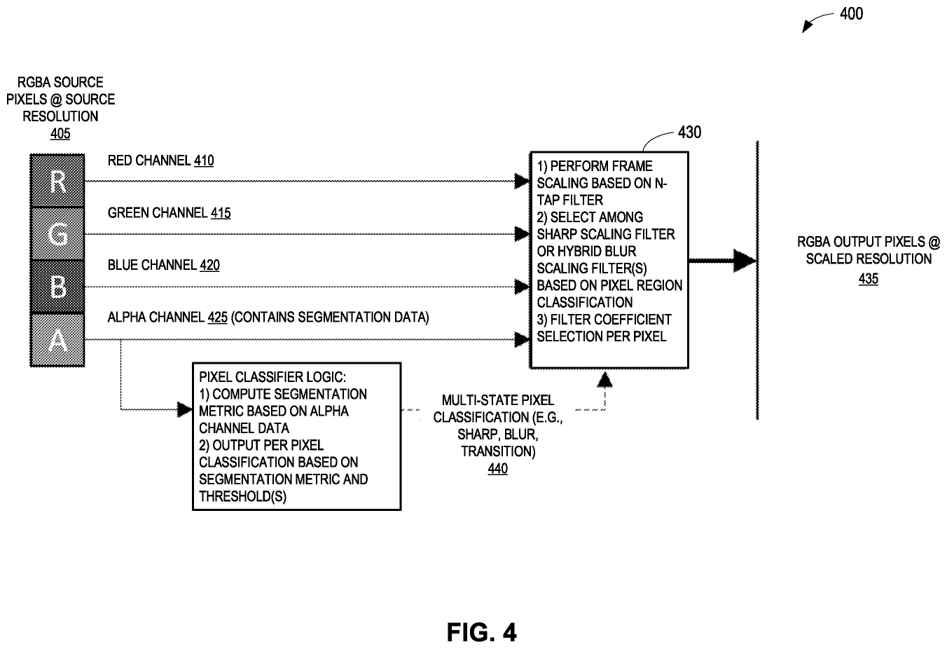

FIG. 4 illustrates an example blur-enabled frame resolution scaling process 400 implemented by the blur-enabled resolution scaling circuitry 170 of FIG. 1. The example process 400 provides a summary of the operations performed by the blur-enabled resolution scaling circuitry 170. In the example process 400 of FIG. 4, the blur-enabled resolution scaling circuitry 170 receives or otherwise obtains example source pixel data 405 for a source frame 184 from the driver. The source pixel data 405 is in RGBA format with a red color channel 410, a green color channel 415, a blue color channel 420 and an alpha channel 425. The alpha channel 425 includes segmentation data determined by the active application 160 for respective source pixels of the source pixel data 405.

In the illustrated example, the blur-enabled resolution scaling circuitry 170 performs example frame resolution scaling operations 430 that are based on an N-tap FIR filter, such as the polyphase FIR filter of Equation 1. As part of the frame resolution scaling operations 430, for a given output pixel of the output frame 180, the blur-enabled resolution scaling circuitry 170 selects among the sharp resolution scaling filter A_{φ}[k] or one or more hybrid blurring filters, such as the hybrid blur resolution scaling filter H_{φ}[k] and/or the hybrid the transition resolution scaling filter H₂_{_{φ}}[k] to be used to perform resolution scaling associated with that output pixel to produce example output pixel data 435 at a resolution that may be different from the source resolution of the source pixel data 405. In the frame resolution scaling operations 430, the filter selection is based on a region classification determined for the given output pixel of the output frame 180, with such selection occurring on a pixel-by-pixel basis for each output pixel.

In the illustrated example operation 400 of FIG. 4, the region classification for a given output pixel is an example multi-state classification 440 that corresponds to one of multiple possible region classifications. For example, the possible region classifications can include a sharp region classification, a blur region classification, a transition region classification, etc. In the illustrated example, the blur-enabled resolution scaling circuitry 170 performs example pixel classification operations 445 to determine the region classifications for respective output pixels of the output frame 180. As part of the pixel classification operations 445, the blur-enabled resolution scaling circuitry 170 computes a segmentation metric for a given output pixel based on the alpha channel segmentation values for the source pixels used to generate that output pixel. As part of the pixel classification operations 445, the blur-enabled resolution scaling circuitry 170 also determines and outputs a per-pixel region classification for the given output pixel based on the computed segmentation metric for that output pixel and one or more region thresholds. Further details concerning region classification operations performed by the blur-enabled resolution scaling circuitry 170 are provided below.

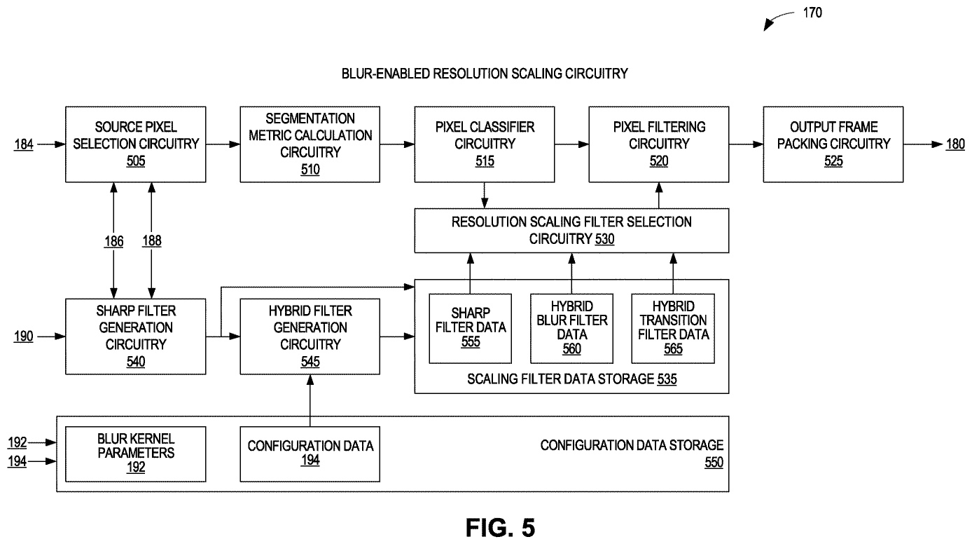

FIG. 5 is a block diagram of an example implementation of the blur-enabled resolution scaling circuitry 170 of FIG. 1. The blur-enabled resolution scaling circuitry 170 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the blur-enabled resolution scaling circuitry 170 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example blur-enabled resolution scaling circuitry 170 of FIG. 5 includes example source pixel selection circuitry 505, example segmentation metric calculation circuitry 510, example pixel classifier circuitry 515, example pixel filtering circuitry 520, example output frame packing circuitry 525, example resolution scaling filter selection circuitry 530, example scaling filter data storage 535, example sharp filter generation circuitry 540, example hybrid filter generation circuitry 545 and example configuration data storage 550. With reference to the preceding figures, the source pixel selection circuitry 505 of the illustrated example selects, using any appropriate past, present and/or future technique, an example group, or set, of source pixels 210 of the source frame 184 to be used to generate a corresponding example output pixel 215 of the output frame 180. In some examples, the source pixel selection circuitry 505 performs such source pixel selection based on the source resolution data 186, the output resolution data 188 and the tap size N of the resolution scaling filter 205. In some examples, the source pixels 210 selected by the source pixel selection circuitry 505 correspond to Src[k] source pixels of Equation 1, and the output pixel 215 corresponds to the Out pixel of Equation 1.

The segmentation metric calculation circuitry 510 and the pixel classifier circuitry 515 of the illustrated example cooperate to determine a region classification for a given output pixel 215 of the output frame 180 based on the segmentation values included in the alpha channels of the source pixels 210 selected by the source pixel selection circuitry 505 for that given output pixel 215. In some examples, to perform such region classification, the segmentation metric calculation circuitry 510 inspects the alpha channel segmentation values for the selected source pixels 210 corresponding to a particular output pixel 215 before any resolution scaling and/or blurring operations are performed. For example, the segmentation metric calculation circuitry 510 may fetch the alpha channel segmentation values using the same tap footprint and phase positions as the R, G and B color channels, ensuring deterministic alignment and allowing region classification to operate with no extra sampling above what is used for frame resolution scaling.

In the illustrated example, the segmentation metric calculation circuitry 510 determines a segmentation metric based on the fetched alpha channel segmentation values associated with the selected source pixels 210 corresponding to a particular output pixel 215, as well as the sharp resolution scaling filter A_{φ}[k] to be used by the blur-enabled resolution scaling circuitry 170 to perform frame resolution scaling without additional region-specific blurring. In some examples, the segmentation metric calculation circuitry 510 uses the alpha channel segmentation values associated with the selected source pixels 210 corresponding to a particular output pixel 215, and the sharp resolution scaling filter A_{φ}[k] to be used for frame resolution scaling without additional region-specific blurring, to compute the segmentation metric as a ratio of a numerator value divided by a denominator value.

In the illustrated example, the segmentation metric calculation circuitry 510 computes the numerator value of the segmentation metric based on the sum of the non-negative tap weights (e.g., sum of the non-negative filter coefficients) of the sharp resolution scaling filter A_{φ}[k] according to Equation 3, which is:

$${W}_{sum} = {\sum }_{k = 0}^{N - 1} max ( 0 , {A}_{φ} [ m ] ) \qquad Equation 3$$

The denominator value Wₛᵤₘ of Equation 3 represents an aggregate coverage metric, or total footprint weight, associated with the sharp resolution scaling filter A_{φ}[k]. In examples in which the tap weights (e.g., filter coefficients) of the sharp resolution scaling filter A_{φ}[k] are non-negative values, the summation of Equation 3 can be simplified to be a sum of the tap weights (e.g., sum of the filter coefficients) without employing the max( ) operation.

In the illustrated example, the segmentation metric calculation circuitry 510 computes the numerator value of the segmentation metric based on the sum of the tap weights (e.g., sum of the filter coefficients) of the sharp resolution scaling filter A_{φ}[k] that cover (e.g., weight, multiply, etc.) source pixels 210 that have alpha channel values that satisfy (e.g., exceed, or meet or exceed) a segmentation threshold. For example, the segmentation metric calculation circuitry 510 can perform such a numerator value computation according to Equation 4, which is:

$${W}_{cov} = {\sum }_{k with {α}_{src} [ k ] > AlphaMin} ( {A}_{φ} [ k ] ) \qquad Equation 4$$

The numerator value W_{cov} of Equation 4 represents a sum of the tap weights (e.g., a sum of the filter coefficients) of the sharp resolution scaling filter A_{φ}[k] that cover (e.g., weight, multiply, etc.) source pixels 210 that have alpha channel values α_{src}[k] that satisfy (e.g., exceed, or meet or exceed) a segmentation threshold AlphaMin. In some examples, the segmentation threshold AlphaMin is programmable via the configuration data 194.

In the illustrated example, the segmentation metric calculation circuitry 510 computes the segmentation metric C_{α} for the given output pixel 215 as a ratio of the numerator value W_{cov} of Equation 4 divided by the denominator value Wₛᵤₘ of Equation 3 as given by Equation 5, which is:

$${C}_{α} = \frac{{W}_{cov}}{{W}_{sum}} \qquad Equation 5$$

The segmentation metric C_{α} of Equation 5 has values in the range of 0 to 1 and represents the fractional coverage of sharp region content in the resolution scaling filter footprint for the given output pixel 215. As such, the values of the segmentation metric C_{α} close to 1 indicate the given output pixel 215 corresponds to a sharp region, and values of the segmentation metric C_{α} close to 0 indicate the output pixel 215 corresponds to a blur region.

The pixel classifier circuitry 515 of the illustrated example uses the segmentation metric C_{α} computed by the segmentation metric calculation circuitry 510 for a given output pixel 215 to determine a region classification for that output pixel 215. In some examples, the region classification determined by the pixel classifier circuitry 515 for a given output pixel 215 is one of multiple possible regions, such as one of a sharp region or a blur region, or such as one or a sharp region, a blur region or a transition region, etc. Furthermore, in some examples, the pixel classifier circuitry 515 classifies a given output pixel 215 into one of the sharp region, the blur region or the transition region based on comparison of the output pixel's segmentation metric C_{α} to one or more region thresholds.

In some such examples, the pixel classifier circuitry 515 performs a two-region classification of a given output pixel 215 into either a sharp region or a blur region based on comparison of the output pixel's segmentation metric C_{α} to a single region threshold, which may be referred to as a sharp region threshold. For example, the pixel classifier circuitry 515 may classify the given output pixel 215 in the sharp region if the output pixel's segmentation metric C_{α} satisfies (e.g., exceeds, or meets or exceeds, etc.) the sharp region threshold, and may classify the given output pixel 215 in the blur region if the output pixel's segmentation metric C_{α} does not satisfy (e.g., does not meet or exceed, etc.) the sharp region threshold. In some such examples, based on classification of the output pixel 215 in the sharp region, the pixel classifier circuitry 515 sets the alpha channel value for that output pixel 215 equal to 1 to indicate the output pixel 215 is classified in the sharp region of the output frame 180. Alternatively, in some examples, the pixel classifier circuitry 515 sets the alpha channel value for that output pixel 215 equal to the pixel's segmentation metric C_{α} to indicate the output pixel 215 is classified in the sharp region of the output frame 180. Conversely, in some such examples, based on classification of the output pixel 215 in the blur region, the pixel classifier circuitry 515 also sets the alpha channel value for that output pixel 215 equal to 0 to indicate the output pixel 215 is classified in the blur region of the output frame 180.

However, in some examples, the pixel classifier circuitry 515 performs a three-region classification of a given output pixel 215 into a sharp region, a blur region or a transition region based on comparison of the output pixel's segmentation metric C_{α} to two region thresholds, which may be referred to as a sharp region threshold and a blur region threshold. For example, the pixel classifier circuitry 515 may classify the given output pixel 215 in the sharp region if the output pixel's segmentation metric C_{α} satisfies (e.g., exceeds, or meets or exceeds, etc.) the sharp region threshold, may classify the given output pixel 215 in the blur region if the output pixel's segmentation metric C_{α} does not satisfy (e.g., does not meet or exceed, etc.) the blur region threshold, and may classify the given output pixel 215 in the transition region if the output pixel's segmentation metric C_{α} does not satisfy the sharp region threshold but satisfies the blur region threshold (e.g., is between the sharp region threshold and the blur region threshold). An example of such a three-region classification can be represented mathematically according to Equation 6, which is:

$${RegionClass}_{OUT} = \{ \begin{matrix}Sharp region & if {C}_{α} \geq {RegionThresh}_{Sharp} \\ Blur region & if {C}_{α} \leq {RegionThresh}_{Blur} \\ Transition region & otherwise\end{matrix} \qquad Equation 6$$

In Equation 6, RegionThresh_{Sharp}, represents the sharp region threshold, RegionThresh_{Blur} represents the blur region threshold, and RegionClass_{OUT} represents the region classification determined for the output pixel Out.

Furthermore, in at least some three-region classification examples, based on classification of the output pixel 215 in the sharp region, the pixel classifier circuitry 515 sets the alpha channel value for that output pixel 215 equal to 1. Alternatively, in some examples, the pixel classifier circuitry 515 sets the alpha channel value for that output pixel 215 equal to the pixel's segmentation metric C_{α} to indicate the output pixel 215 is classified in the sharp region of the output frame 180. However, based on classification of the output pixel 215 in the blur region, the pixel classifier circuitry 515 sets the alpha channel value for that output pixel 215 equal to 0 to indicate the output pixel 215 is classified in the blur region of the output frame 180. However, based on classification of the output pixel 215 in the transition region, the pixel classifier circuitry 515 sets the alpha channel value for that output pixel 215 equal to an intermediate value, such as 0.5 or some other value, to indicate the output pixel 215 is classified in the transition region of the output frame 180. Alternatively, in some examples, the pixel classifier circuitry 515 sets the alpha channel value for that output pixel 215 equal to the pixel's segmentation metric C_{α} to indicate the output pixel 215 is classified in the transition region of the output frame 180.

In some examples, the region threshold(s), the type of region classification (e.g., two-region or three-region, etc.) and/or the alpha values to be used to represent the different classification regions are programmable via the configuration data 194.

The pixel filtering circuitry 520 of the illustrated example implements the programmable resolution scaling filter 205 used by the blur-enabled resolution scaling circuitry 170. For example, the programmable resolution scaling filter 205 may be a hardware-based filter with programmable filter coefficients (e.g., programmable tap weights). In some examples, the programmable resolution scaling filter 205 implemented by the pixel filtering circuitry 520 corresponds to the polyphase FIR filter structure of Equation 1.

The resolution scaling filter selection circuitry 530 of the illustrated example uses the region classification determined by the pixel classifier circuitry 515 for a given output pixel 215 to dynamically select between two or more filter coefficient sets, or filter tap sets, to be used by the pixel filtering circuitry 520 to combine the selected source pixels 210 of the source frame 184 to generate the given output pixel 215 of the output frame 180. For example, if the resolution scaling filter 205 implemented by the pixel filtering circuitry 520 corresponds to the resolution scaling FIR filter structure of Equation 1, the resolution scaling filter selection circuitry 530 uses the region classification for the given output pixel 215 to select between two or more filter coefficient sets to be used to program the filter coefficient set f_{φ}[k] of Equation 1. In the illustrated example, the available filter coefficient sets include the sharp resolution scaling filter A_{φ}[k] that performs resolution scaling without employing region-specific blurring (e.g., to preserve detail in sharp region(s) of a frame), the hybrid blur resolution scaling filter H_{φ}[k] that performs region-specific blurring along with resolution scaling (e.g., to blur, obfuscate, etc., detail in blur region(s) of a frame), and the hybrid transition resolution scaling filter H₂_{_{φ}}[k] that performs resolution scaling region along with weaker, or lighter, blurring than performed by the blur resolution scaling filter H_{φ}[k] (e.g., to blend detail between sharp region(s) and blur region(s) of a frame). In the illustrated example, the filter coefficients (e.g., tap weights) of the sharp resolution scaling filter A_{φ}[k] are stored as example sharp filter data 555 in the scaling filter data storage 535, the filter coefficients (e.g., tap weights) of the hybrid blur resolution scaling filter H_{φ}[k] are stored as example hybrid blur filter data 560 in the scaling filter data storage 535, and the filter coefficients (e.g., tap weights) of the transition resolution scaling filter H₂_{_{φ}}[k] are stored as hybrid transition filter data 565 in the scaling filter data storage 535.

In an example filter selection based on two-region classification, the resolution scaling filter selection circuitry 530 uses the region classification determined by the pixel classifier circuitry 515 for the given output pixel 215 to dynamically select between the sharp resolution scaling filter A_{φ}[k] or the hybrid blur resolution scaling filter H_{φ}[k] to perform frame resolution scaling for that given output pixel 215. For example, the resolution scaling filter selection circuitry 530 may select the sharp resolution scaling filter A_{φ}[k] if the region classification for the given output pixel 215 corresponds to the sharp region, and may select the hybrid blur resolution scaling filter H_{φ}[k] if the region classification for the given output pixel 215 corresponds to the blur region. In an example filter selection based on three-region classification, the resolution scaling filter selection circuitry 530 uses the region classification determined by the pixel classifier circuitry 515 for the given output pixel 215 to dynamically select between the sharp resolution scaling filter A_{φ}[k], the hybrid blur resolution scaling filter H_{φ}[k] or the transition resolution scaling filter H₂_{_{φ}}[k] to perform frame resolution scaling for that given output pixel 215. For example, the resolution scaling filter selection circuitry 530 may select the sharp resolution scaling filter A_{φ}[k] if the region classification for the given output pixel 215 corresponds to the sharp region, may select the hybrid blur resolution scaling filter H_{φ}[k] if the region classification for the given output pixel 215 corresponds to the blur region, and may select the transition resolution scaling filter H₂_{_{φ}}[k] if the region classification for the given output pixel 215 corresponds to the transition region.

In some examples, the resolution scaling filter selection circuitry 530 programs or otherwise configures the resolution scaling filter 205 implemented by the pixel filtering circuitry 520 by programming or otherwise configuring the pixel filtering circuitry 520 to access the filter coefficient set f_{φ}[k] to be used by the resolution scaling filter 205 for a given output pixel 215 from the appropriate filter data set stored in the scaling filter data storage 535. For example, if the resolution scaling filter selection circuitry 530 selects the sharp resolution scaling filter A_{φ}[k] for the given output pixel 215, the scaling filter selection circuitry 530 may program or otherwise configure the pixel filtering circuitry 520 with the base memory address, register address, or other storage location, etc., of the sharp filter data 555 in the scaling filter data storage 535. However, if the resolution scaling filter selection circuitry 530 selects the blur resolution scaling filter H_{φ}[k] for the given output pixel 215, the scaling filter selection circuitry 530 may program or otherwise configure the pixel filtering circuitry 520 with the base memory address, register address, or other storage location, etc., of the hybrid blur filter data 560 in the scaling filter data storage 535. However, if the resolution scaling filter selection circuitry 530 selects the transition resolution scaling filter H₂_{_{φ}}[k] for the given output pixel 215, the scaling filter selection circuitry 530 may program or otherwise configure the pixel filtering circuitry 520 with the base memory address, register address, or other storage location, etc., of the hybrid transition filter data 565 in the scaling filter data storage 535.

In some examples, the resolution scaling filter selection circuitry 530 interpolates or blends the available filter coefficient sets (e.g., the sharp resolution scaling filter A_{φ}[k], hybrid blur resolution scaling filter H_{φ}[k], the transition resolution scaling filter H₂_{_{φ}}[k], etc.) based on a smoothing function to generate the filter coefficient set f_{φ}[k] to be used by the pixel filtering circuitry 520 to implement the resolution scaling filter 205. In some such examples, the smoothing function determines a set of one or more blending weights w_{blend} based on the segmentation metric C_{α} determined for a given output pixel 215 and the one or more region thresholds (e.g., RegionThresh_{Sharp}, RegionThresh_{Blur}, etc.) described above. For example, the resolution scaling filter selection circuitry 530 can determine the blending weights w_{blend} based on Equation 7, which is:

$${w}_{blend} = smooth\_function ( {C}_{α} , {RegionThresh}_{Sharp} , {RegionThresh}_{Blur} ) \qquad Equation 7$$

In Equation 7, smooth_function( ) can be any function, such as a piecewise linear function, that determines blending weights w_{blend} to emphasize the coefficients (e.g., tap weights) of one or more of the available filter coefficient sets (e.g., the sharp resolution scaling filter A_{φ}[k], hybrid blur resolution scaling filter H_{φ}[k], the transition resolution scaling filter H₂_{_{φ}}[k], etc.), and deemphasize the coefficients (e.g., tap weights) of the other one or more of the available filter coefficient sets, based on the value of the segmentation metric C_{α} determined for a given output pixel 215 relative to the one or more region thresholds (e.g., RegionThresh_{Sharp}, RegionThresh_{Blur}, etc.).

In some examples, based on the blending weights w_{blend} determined for a given output pixel 215, the resolution scaling filter selection circuitry 530 determines the filter coefficient set f_{φ}[k] to be used to program, configure, etc., by the pixel filtering circuitry 520 for the given output pixel based on a blending function. For example, the resolution scaling filter selection circuitry 530 can determine the filter coefficient set f_{φ}[k] based on Equation 8, which is:

$${f}_{φ} [ k ] = blend ( {A}_{φ} [ k ] , {H}_{{2}_{φ}} [ k ] , {H}_{φ} [ k ] , {w}_{blend} ) \qquad Equation 8$$

In Equation 8, blend( ) can be any function that combines the coefficients (e.g., tap weights) of the available filter coefficient sets (e.g., the sharp resolution scaling filter A_{φ}[k], hybrid blur resolution scaling filter H_{φ}[k], the transition resolution scaling filter H₂_{_{φ}}[k], etc.) based on the blending weights w_{blend}. In examples in which the resolution scaling filter 205 implemented by the pixel filtering circuitry 520 corresponds to the polyphase FIR filter structure of Equation 1, the filter coefficient set f_{φ}[k] of Equation 8 results in the resolution scaling filter selection circuitry 530 generating the output pixel 215 based on the source pixels 210 according to Equation 9, which is:

$$Out = {\sum }_{k = 0}^{N - I} blend ( {A}_{φ} [ k ] , {H}_{{2}_{φ}} [ k ] , {H}_{φ} [ k ] , {w}_{blend} ) \cdot Src [ k ] \qquad Equation 9$$

Equation 9 can provide frame resolution scaling with region-specific blurring having smooth transitions with reduced or no visible halos at region boundaries.

The sharp filter generation circuitry 540 of the illustrated example computes or otherwise determines the sharp resolution scaling filter A_{φ}[k] to be used by the blur-enabled resolution scaling circuitry 170. In some examples, the sharp filter generation circuitry 540 determines the sharp resolution scaling filter A_{φ}[k] based on the sharp resolution scaling filter coefficient set 190, the source resolution data 186 and the output resolution data 188 provided by the driver 165. For example, the sharp resolution scaling filter coefficient set 190 can have a generic peaked filter response that combines a group of source pixels to generate an output pixel that preserves sharp detail. In some examples, the sharp filter generation circuitry 540 can use any past, present or future filter generation algorithm, to generate the filter coefficients (e.g., tap weights) for the sharp resolution scaling filter A_{φ}[k] by modifying the generic filter response of the sharp resolution scaling filter coefficient set 190 to map the source resolution of the source frame 184 as specified by the source resolution data 186 to the output resolution of the output frame 180 as specified by the output resolution data 188. The sharp filter generation circuitry 540 of the illustrated example stores the generated filter coefficients (e.g., tap weights) of the sharp resolution scaling filter A_{φ}[k] as the sharp filter data 555 in the scaling filter data storage 535.

The hybrid filter generation circuitry 545 of the illustrated example computes or otherwise determines the hybrid filter(s) to be used by the blur-enabled resolution scaling circuitry 170. For example, the hybrid filter generation circuitry 545 generates the hybrid blur resolution scaling filter H_{φ}[k] and/or the hybrid transition resolution scaling filter H₂_{_{φ}}[k] used by the blur-enabled resolution scaling circuitry 170. In some examples, the hybrid filter generation circuitry 545 generates the hybrid blur resolution scaling filter H_{φ}[k] based on the sharp resolution scaling filter A_{φ}[k] generated by the sharp filter generation circuitry 540, the blur filter kernel 192 provided by the driver 165, and one or more filter fusion parameters provided by the driver 165. In some examples, the blur filter kernel 192 has a flat or relatively flat filter response that blends (e.g., averages) a group of source pixels to generate an output pixel with blurred detail. The hybrid filter generation circuitry 545 of the illustrated example combines the blur filter kernel 192 with the sharp resolution scaling filter A_{φ}[k] based on a fusion technique specified by the configuration data 194 to produce the hybrid blur resolution scaling filter H_{φ}[k] that is able to perform both frame resolution scaling and region-specific blurring of a group of source pixels 210 to produce an output pixel 215.

Similarly, in some examples, the hybrid filter generation circuitry 545 generates the hybrid transition resolution scaling filter H₂_{_{φ}}[k] based on the sharp resolution scaling filter A_{φ}[k] generated by the sharp filter generation circuitry 540, a transition filter kernel provided in the configuration data 194 from the driver 165, and one or more filter fusion parameters provided by the driver 165. In some examples, the transition filter kernel 192 has a rounder filter response than the blur filter kernel 192, but is not as peaked as the sharp resolution scaling filter coefficient set 190, that blends (e.g., combines) a group of source pixels to generate an output pixel with partially blurred detail. In some examples, the hybrid filter generation circuitry 545 of the illustrated example combines the transition filter kernel with the sharp resolution scaling filter A_{φ}[k] based on a fusion technique specified by the configuration data 194 to produce the hybrid transition resolution scaling filter H₂_{_{φ}}[k] that is able to perform both frame resolution scaling and transition region blending of a group of source pixels 210 to produce an output pixel 215.

In some examples, the hybrid filter generation circuitry 545 implements one or more coefficient fusion techniques to combine the blur filter kernel 192 with the sharp resolution scaling filter A_{φ}[k] to produce the hybrid blur resolution scaling filter H_{φ}[k], and or to combine the transition filter kernel with the sharp resolution scaling filter A_{φ}[k] to produce the hybrid transition resolution scaling filter H₂_{_{φ}}[k]. For example, the coefficient fusion technique(s) implemented by the hybrid filter generation circuitry 545 may include one or more of a filter averaging fusion technique, a weighted filter averaging fusion technique and a nonlinear filter fusion technique. In some such examples, the particular fusion technique to be used by the hybrid filter generation circuitry 545 is specified in the configuration data 194 provided by the driver 165.

In some examples, the filter averaging fusion technique implemented by the hybrid filter generation circuitry 545 for hybrid blur filter generation involves averaging the filter coefficients (e.g., the tap weights) of the sharp resolution scaling filter A_{φ}[k] with corresponding tap weights of the blur filter kernel, represented by B[k], to generate the hybrid blur resolution scaling filter H_{φ}[k] according to Equation 10, which is:

$${H}_{φ} [ k ] = ( {A}_{φ} [ k ] + B [ k ] ) / 2 \qquad Equation 10$$

Similarly, in some examples, the filter averaging fusion technique implemented by the hybrid filter generation circuitry 545 for hybrid transition filter generation involves averaging the filter coefficients (e.g., the tap weights) of the sharp resolution scaling filter A_{φ}[k] with corresponding tap weights of the transition filter kernel, represented by T[k], to generate the hybrid blur resolution scaling filter H₂_{_{φ}}[k] according to Equation 11, which is:

$${H}_{{2}_{φ}} [ k ] = ( {A}_{φ} [ k ] + T [ k ] ) / 2 \qquad Equation 11$$

In some examples, the weighted filter averaging fusion technique implemented by the hybrid filter generation circuitry 545 for hybrid blur filter generation involves performing a weighted averaging of the filter coefficients (e.g., the tap weights) of the sharp resolution scaling filter A_{φ}[k] with corresponding tap weights of the blur filter kernel, represented by B[k], based on a blend factor represented by A, to generate the hybrid blur resolution scaling filter H_{φ}[k] according to Equation 12, which is:

$${H}_{φ} [ k ] = λ \cdot {A}_{φ} [ k ] + ( 1 - λ ) \cdot B [ k ] \qquad Equation 12$$

In Equation 12, the blend factor A is a value in the range of 0 to 1. In some examples, the blend factor A is programmable based on the configuration data 194 provided by the driver 165.

In some examples, the weighted filter averaging fusion technique implemented by the hybrid filter generation circuitry 545 for hybrid transition filter generation involves performing a weighted averaging of the filter coefficients (e.g., the tap weights) of the sharp resolution scaling filter A_{φ}[k] with corresponding tap weights of the transition filter kernel, represented by T[k], based on a blend factor represented by A, to generate the hybrid transition resolution scaling filter H₂_{_{φ}}[k] according to Equation 13, which is:

$${H}_{{2}_{φ}} [ k ] = λ \cdot {A}_{φ} [ k ] + ( 1 - λ ) \cdot T [ k ] \qquad Equation 13$$

In Equation 13, the blend factor A is a value in the range of 0 to 1. In some examples, the blend factor λ is programmable based on the configuration data 194 provided by the driver 165. In some examples, the blend factor used in Equation 12 for hybrid blur filter generation is different from the blend factor used in Equation 13 for hybrid transition filter generation. In some examples, the hybrid filter generation circuitry 545 uses the blur filter kernel, B[k], for both hybrid blur filter generation and hybrid transition filter generation, but employs a different (e.g., smaller) value of the blend factor A for hybrid blur filter generation than for hybrid transition filter generation.

In some examples, the nonlinear filter fusion technique implemented by the hybrid filter generation circuitry 545 for hybrid blur filter generation involves performing a nonlinear combination (e.g., a nonlinear selection) between ones of the filter coefficients (e.g., the tap weights) of the sharp resolution scaling filter A_{φ}[k] and corresponding ones of the filter coefficients (e.g., the tap weights) of the blur filter kernel B[k] to generate the hybrid blur resolution scaling filter H_{φ}[k]. In some examples, the nonlinear combination (e.g., nonlinear selection) of the filter coefficients is based on one or more nonlinear operations such as a max( ) operation, a min( ) operation, a threshold switching operation, a directional selection operation for anisotropic blur, etc. For example, a nonlinear filter fusion technique that can be implemented by the hybrid filter generation circuitry 545 for hybrid blur filter generation is given by Equation 14, which is:

$${H}_{φ} [ k ] = max ( {A}_{φ} [ k ] , B [ k ] ) \qquad Equation 14$$

In some examples, the nonlinear filter fusion technique implemented by the hybrid filter generation circuitry 545 for hybrid transition filter generation involves performing a nonlinear combination (e.g., a nonlinear selection) between ones of the filter coefficients (e.g., the tap weights) of the sharp resolution scaling filter A_{φ}[k] and corresponding ones of the filter coefficients (e.g., the tap weights) of the transition filter kernel T[k] to generate the hybrid transition resolution scaling filter H₂_{_{φ}}[k]. In some examples, the nonlinear combination (e.g., nonlinear selection) of the filter coefficients is based on one or more nonlinear operations such as a max( ) operation, a min( ) operation, a threshold switching operation, a directional selection operation for anisotropic blur, etc. For example, a nonlinear filter fusion technique that can be implemented by the hybrid filter generation circuitry 545 for hybrid transition filter generation is given by Equation 15, which is:

$${H}_{{2}_{φ}} [ k ] = max ( {A}_{φ} [ k ] , T [ k ] ) \qquad Equation 15$$

In some examples, the nonlinear filter fusion techniques implemented by the hybrid filter generation circuitry 545, such as the technique of Equation 14 and/or Equation 15, involve no additional memory reads or writes because the filter coefficients selected by the nonlinear operation can directly feed the multiple-and-accumulate operations of the filter structure. Also, in some examples, any of the filter fusion techniques described above can operate within an N-tap FIR filter architecture with no additional taps or memory traffic involved.

The output frame packing circuitry 525 of the illustrated example packs the output pixels 215 generated by the pixel filtering circuitry 520 into an output frame 180. For example, the output frame packing circuitry 525 can pack the output pixels 215 into the output frame in an RGBA format with the R, G and B color values determined by the resolution scaling filter implemented by the pixel filtering circuitry 520, as described above. In some examples, the output frame packing circuitry 525 sets the alpha values of the output pixels 215 based on the region classification operations described above.

The configuration data storage 550 of the illustrated example stores the blur kernel filter data 192 and the configuration parameter data 194 provided by the driver 165. The configuration data storage 550 and/or the scaling filter data storage 535 can be implemented by any combination of memory circuits and/or devices, storage circuits and/or devices, etc.

In some examples, the blur-enabled resolution scaling circuitry 170 of the illustrated examples implemented multi-stage cascaded frame resolution scaling with region-specific blurring to provide additional content obfuscation. In some such examples, the blur-enabled resolution scaling circuitry 170 chains multiple scaler/blur stages together, with each stage performing independent scaling and alpha-driven blurring, with the alpha channel data for the output frame of a given stage, also referred to as the alpha mask for the output frame, being resampled and propagated to guide subsequent stages. The following is an example of multi-stage cascaded frame resolution scaling with region-specific blurring.

In the first stage of the example, the resolution scale factor, which corresponds to the ratio of the output frame resolution to the source frame resolution, is set to 1.0 (e.g., corresponding to no resolution scaling). Thus, in the first stage, the blur-enabled resolution scaling circuitry 170 performs region-specific blurring on the source frame based on the source alpha channel data (e.g., source alpha mask) corresponding to the source frame to generate a first stage output image with blur region(s) corresponding to the source alpha mask. The alpha channel mask for the first stage output image is the same as the source alpha mask because no resolution scaling was performed.

In the second stage of the example, the resolution scale factor, which corresponds to the ratio of the output frame resolution to the source frame resolution, is set to 0.5 (e.g., corresponding to resolution down-scaling by a factor of 2). Thus, in the second stage, the blur-enabled resolution scaling circuitry 170 performs frame resolution scaling with region-specific blurring based on the first stage alpha channel data (e.g., first stage alpha mask) corresponding to the first stage output frame to generate a second stage output image with blur region(s) corresponding to the first stage alpha mask. The blur region(s) of the second stage output frame are further blurred relative to the blur region(s) of the first stage output frame due to the additional filtering applied in the second stage. The alpha channel mask for the second stage output image is also down-sampled by a factor of 2 based on the frame resolution scaling, with the alpha values for the second stage alpha mask determined as described above.

In the third stage of the example, the resolution scale factor, which corresponds to the ratio of the output frame resolution to the source frame resolution, is set to 2.0 (e.g., corresponding to resolution up-scaling by a factor of 2). Thus, in the third stage, the blur-enabled resolution scaling circuitry 170 performs frame resolution scaling with region-specific blurring based on the second stage alpha channel data (e.g., second stage alpha mask) corresponding to the second stage output frame to generate a third stage output image with blur region(s) corresponding to the second stage alpha mask. The blur region(s) of the third stage output frame are further blurred relative to the blur region(s) of the second stage output frame due to the additional filtering applied in the third stage. The alpha channel mask for the third stage output image is also up-sampled by a factor of 2 based on the frame resolution scaling, with the alpha values for the third stage alpha mask determined as described above.

Thus, in the preceding examples, the blur region(s) accumulate blur across multiple stages. However, the sharp region(s) maintain detail through the different stages. In some examples, such a cascaded approach enables arbitrarily strong blur that would require hundreds of taps in a single-stage implementation. For example, a 3-stage cascade approach with 8 taps per stage can achieve blur strength equivalent to a single-pass approach having a 64-tap filter.

In view of the foregoing description, the blur-enabled resolution scaling circuitry 170 of the illustrated examples provides several advantages over prior resolution scaling techniques. For example, pixel region classification happens before interpolation and applies to both color and alpha channels. The blur-enabled resolution scaling circuitry 170 determines which coefficient set to use for color interpolation (e.g., A_{φ}, H_{φ}, or H₂_{_{φ}}) of a given output pixel 215, and whether to perform alpha channel interpolation (e.g., by setting the alpha channel value based on the output pixel's segmentation metrics C_{α}) or force the alpha value of the output pixel to zero (e.g., corresponding to a blur region). The blur-enabled resolution scaling circuitry 170 uses the same classification result for all of the RGBA channels, ensuring consistent behavior. In some examples, the alpha output for a given output pixel classified in the blur region bypasses the filtering entirely and is forced to zero. Although color channel filter operations for blur region pixels may still execute using the blur kernel, the output alpha is guaranteed to be zero, enabling downstream composition engines to treat the pixel as belonging to the background region.

Another advantage of the blur-enabled resolution scaling circuitry 170 of the illustrated examples is that its pixel region classification is resolution independent. For example, the segmentation metric C_{α} and corresponding thresholds have consistent meaning regardless of the resolution scale factor. As resolution scaling changes, the tap footprint widens or narrows, but the coverage metric remains interpretable in the same way.

Yet another advantage of the blur-enabled resolution scaling circuitry 170 of the illustrated examples is that it supports single-pass operation, with both resolution scaling and region blurring being performed by a single filtering operation.

Still another advantage of the blur-enabled resolution scaling circuitry 170 of the illustrated examples is that it supports programmable thresholds. For example, the segmentation and/or region threshold described above can be tuned via the driver 165 for different use cases (e.g., such as aggressive blur vs. detail preservation).

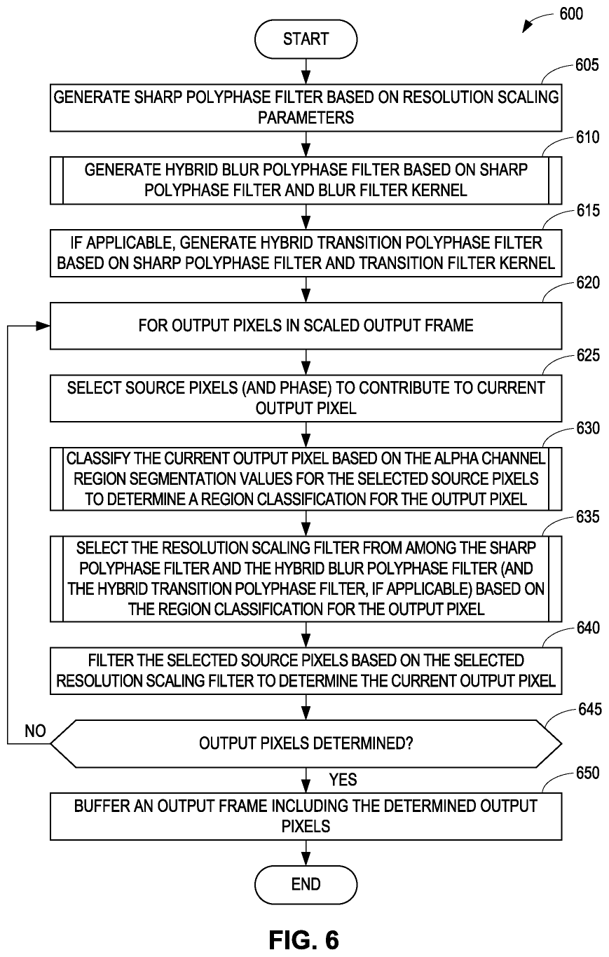

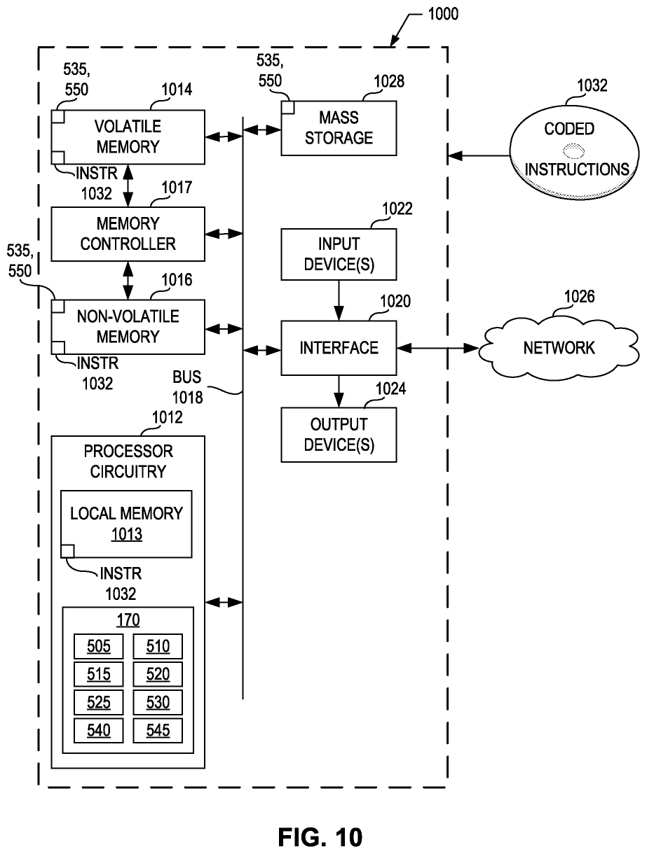

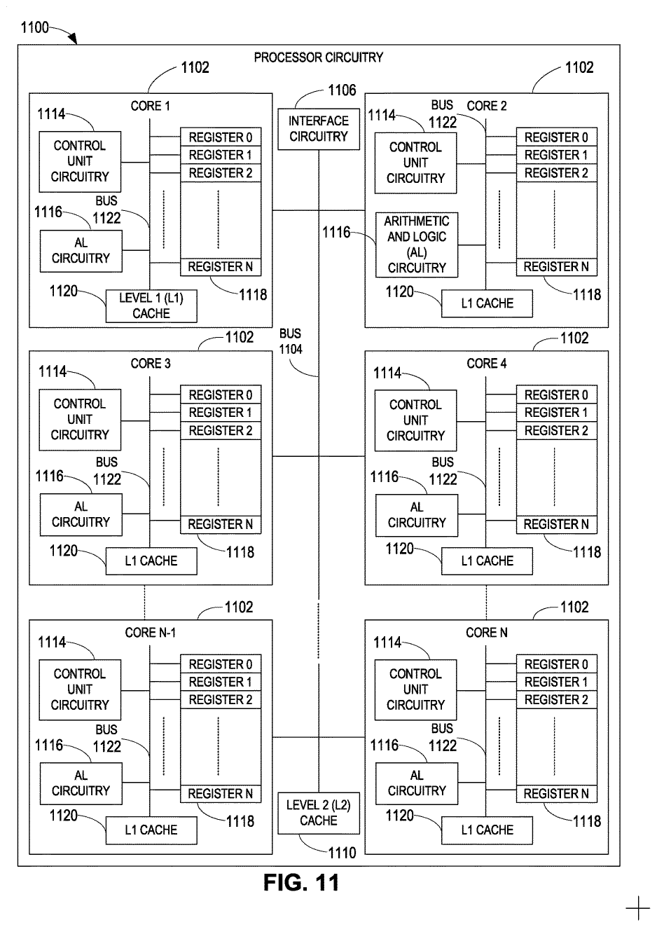

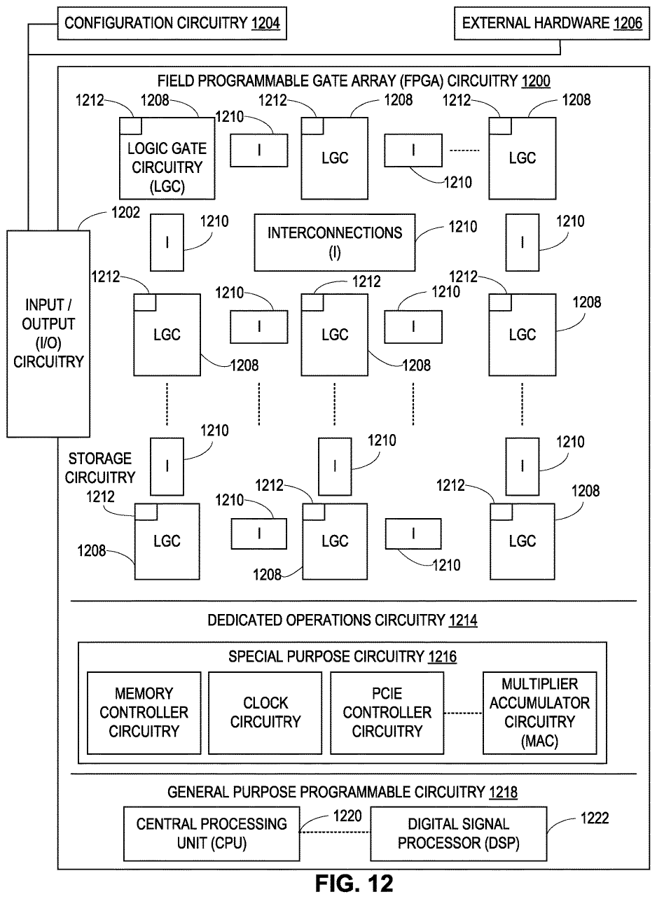

In some examples, the blur-enabled resolution scaling circuitry 170 includes means for selecting source pixels. For example, the means for selecting source pixels may be implemented by the source pixel selection circuitry 505. In some examples, the source pixel selection circuitry 505 may be instantiated by programmable circuitry such as the example programmable circuitry 1012 of FIG. 10. For instance, the source pixel selection circuitry 505 may be instantiated by the example microprocessor 1100 of FIG. 11 executing machine executable instructions such as those implemented by at least block 625 of FIG. 6. In some examples, the source pixel selection circuitry 505 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the source pixel selection circuitry 505 may be instantiated by any other combination of hardware, software, and/or firmware. For example, the source pixel selection circuitry 505 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

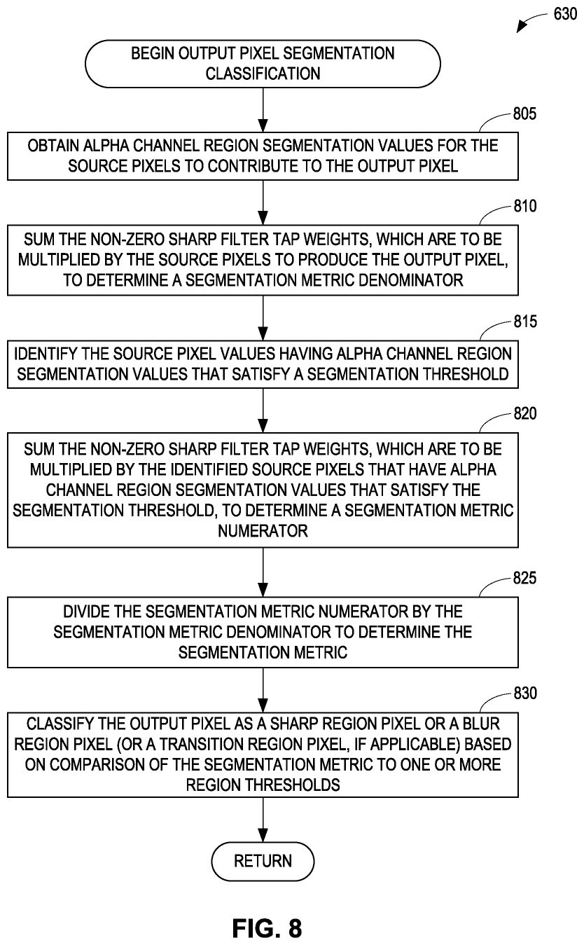

In some examples, the blur-enabled resolution scaling circuitry 170 includes means for calculating a segmentation metric. For example, the means for calculating a segmentation metric may be implemented by the segmentation metric calculation circuitry 510. In some examples, the segmentation metric calculation circuitry 510 may be instantiated by programmable circuitry such as the example programmable circuitry 1012 of FIG. 10. For instance, the segmentation metric calculation circuitry 510 may be instantiated by the example microprocessor 1100 of FIG. 11 executing machine executable instructions such as those implemented by at least block 630 of FIG. 6 and/or blocks 805-825 of FIG. 8. In some examples, the segmentation metric calculation circuitry 510 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the segmentation metric calculation circuitry 510 may be instantiated by any other combination of hardware, software, and/or firmware. For example, the segmentation metric calculation circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the blur-enabled resolution scaling circuitry 170 includes means for classifying pixels. For example, the means for classifying pixels may be implemented by the pixel classifier circuitry 515. In some examples, the pixel classifier circuitry 515 may be instantiated by programmable circuitry such as the example programmable circuitry 1012 of FIG. 10. For instance, the pixel classifier circuitry 515 may be instantiated by the example microprocessor 1100 of FIG. 11 executing machine executable instructions such as those implemented by at least block 630 of FIG. 6 and/or block 830 of FIG. 8. In some examples, the pixel classifier circuitry 515 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the pixel classifier circuitry 515 may be instantiated by any other combination of hardware, software, and/or firmware. For example, the pixel classifier circuitry 515 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the blur-enabled resolution scaling circuitry 170 includes means for filtering pixels. For example, the means for filtering pixels may be implemented by the pixel filtering circuitry 520. In some examples, the pixel filtering circuitry 520 may be instantiated by programmable circuitry such as the example programmable circuitry 1012 of FIG. 10. For instance, the pixel filtering circuitry 520 may be instantiated by the example microprocessor 1100 of FIG. 11 executing machine executable instructions such as those implemented by at least block 640 of FIG. 6. In some examples, the pixel filtering circuitry 520 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the pixel filtering circuitry 520 may be instantiated by any other combination of hardware, software, and/or firmware. For example, the pixel filtering circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the blur-enabled resolution scaling circuitry 170 includes means for frame packing. For example, the means for frame packing may be implemented by the output frame packing circuitry 525. In some examples, the output frame packing circuitry 525 may be instantiated by programmable circuitry such as the example programmable circuitry 1012 of FIG. 10. For instance, the output frame packing circuitry 525 may be instantiated by the example microprocessor 1100 of FIG. 11 executing machine executable instructions such as those implemented by at least block 650 of FIG. 6. In some examples, the output frame packing circuitry 525 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the output frame packing circuitry 525 may be instantiated by any other combination of hardware, software, and/or firmware. For example, the output frame packing circuitry 525 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

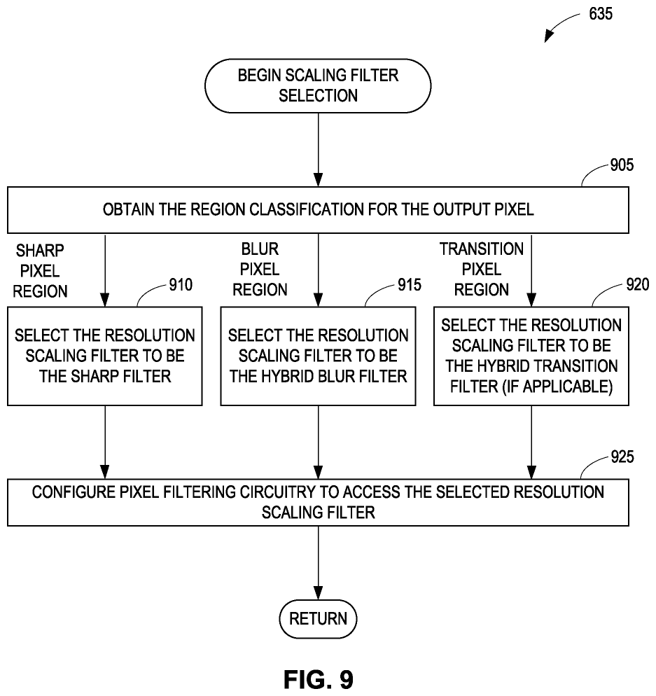

In some examples, the blur-enabled resolution scaling circuitry 170 includes means for selecting a filter. For example, the means for selecting a filter may be implemented by the resolution scaling filter selection circuitry 530. In some examples, the resolution scaling filter selection circuitry 530 may be instantiated by programmable circuitry such as the example programmable circuitry 1012 of FIG. 10. For instance, the resolution scaling filter selection circuitry 530 may be instantiated by the example microprocessor 1100 of FIG. 11 executing machine executable instructions such as those implemented by at least block 635 of FIG. 6, and/or one or more blocks 905-925 of FIG. 9. In some examples, the resolution scaling filter selection circuitry 530 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the resolution scaling filter selection circuitry 530 may be instantiated by any other combination of hardware, software, and/or firmware. For example, the resolution scaling filter selection circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the blur-enabled resolution scaling circuitry 170 includes means for generating a sharp resolution scaling filter. For example, the means for generating a sharp resolution filter may be implemented by the sharp filter generation circuitry 540. In some examples, the sharp filter generation circuitry 540 may be instantiated by programmable circuitry such as the example programmable circuitry 1012 of FIG. 10. For instance, the sharp filter generation circuitry 540 may be instantiated by the example microprocessor 1100 of FIG. 11 executing machine executable instructions such as those implemented by at least block 605 of FIG. 6. In some examples, the sharp filter generation circuitry 540 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the sharp filter generation circuitry 540 may be instantiated by any other combination of hardware, software, and/or firmware. For example, the sharp filter generation circuitry 540 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

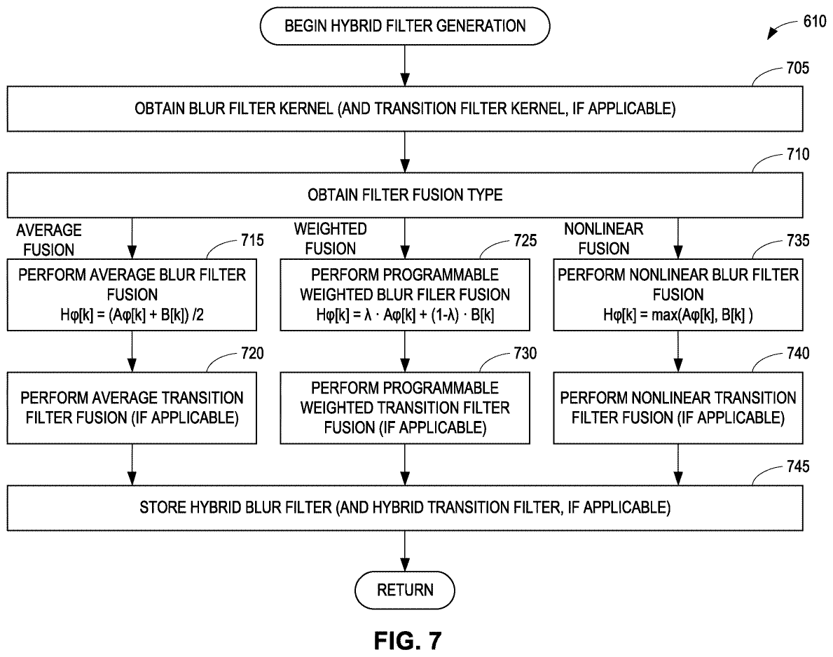

In some examples, the blur-enabled resolution scaling circuitry 170 includes means for generating a hybrid resolution scaling filter. For example, the means for generating a hybrid resolution filter may be implemented by the hybrid filter generation circuitry 545. In some examples, the hybrid filter generation circuitry 545 may be instantiated by programmable circuitry such as the example programmable circuitry 1012 of FIG. 10. For instance, the hybrid filter generation circuitry 545 may be instantiated by the example microprocessor 1100 of FIG. 11 executing machine executable instructions such as those implemented by at least blocks 610 and/or 615 of FIG. 6, and/or one or more blocks 705-745 of FIG. 7. In some examples, the hybrid filter generation circuitry 545 may be instantiated by hardware logic circuitry, which may be implemented by an ASIC, XPU, or the FPGA circuitry 1200 of FIG. 12 configured and/or structured to perform operations corresponding to the machine-readable instructions. Additionally or alternatively, the hybrid filter generation circuitry 545 may be instantiated by any other combination of hardware, software, and/or firmware. For example, the hybrid filter generation circuitry 545 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the blur-enabled resolution scaling circuitry 170 of FIG. 1 is illustrated in FIG. 5, one or more of the elements, processes, and/or devices illustrated in FIG. 5 may be combined, divided, re-arranged, omitted, eliminated, and/or implemented in any other way. Further, the example source pixel selection circuitry 505, the example segmentation metric calculation circuitry 510, the example pixel classifier circuitry 515, the example pixel filtering circuitry 520, the example output frame packing circuitry 525, the example resolution scaling filter selection circuitry 530, the example scaling filter data storage 535, the example sharp filter generation circuitry 540, the example hybrid filter generation circuitry 545, the example configuration data storage 550, and/or, more generally, the example blur-enabled resolution scaling circuitry 170 of FIG. 5, may be implemented by hardware alone or by hardware in combination with software and/or firmware. Thus, for example, any of the example source pixel selection circuitry 505, the example segmentation metric calculation circuitry 510, the example pixel classifier circuitry 515, the example pixel filtering circuitry 520, the example output frame packing circuitry 525, the example resolution scaling filter selection circuitry 530, the example scaling filter data storage 535, the example sharp filter generation circuitry 540, the example hybrid filter generation circuitry 545, the example configuration data storage 550, and/or, more generally, the example blur-enabled resolution scaling circuitry 170, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example blur-enabled resolution scaling circuitry 170 of FIG. 5 may include one or more elements, processes, and/or devices in addition to, or instead of, those illustrated in FIG. 5, and/or may include more than one of any or all of the illustrated elements, processes and devices.

Flowchart(s) representative of example machine-readable instructions, which may be executed by programmable circuitry to implement and/or instantiate the blur-enabled resolution scaling circuitry 170 of FIG. 5 and/or representative of example operations which may be performed by programmable circuitry to implement and/or instantiate the blur-enabled resolution scaling circuitry 170 of FIG. 5, are shown in FIGS. 6-9. The machine-readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 6-9, many other methods of implementing the example blur-enabled resolution scaling circuitry 170 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6-9 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by programmable circuitry to implement the blur-enabled resolution scaling circuitry 170. The example machine-readable instructions and/or the example operations 600 of FIG. 6 begin at block 605, at which the sharp filter generation circuitry 540 of the blur-enabled resolution scaling circuitry 170 generates a sharp polyphase resolution scaling filter (e.g., A_{φ}[k]) based on resolution scaling parameters, as described above. For example, the sharp filter generation circuitry 540 generates the sharp polyphase resolution scaling filter (e.g., A_{φ}[k]) based on the sharp resolution scaling filter coefficient set 190, the source resolution of the source frame 184 as specified by the source resolution data 186, and the output resolution of the output frame 180 as specified by the output resolution data 188, as described above. For example, the sharp filter generation circuitry 540 may determine a resolution scale factor as a ratio of the output resolution divided by the source resolution, and modify the sharp resolution scaling filter coefficient set 190 based on that resolution scale factor to determine the sharp polyphase resolution scaling filter (e.g., A_{φ}[k]).

At block 610, the hybrid filter generation circuitry 545 of the blur-enabled resolution scaling circuitry 170 generates a hybrid blur polyphase filter (e.g., H_{φ}[k]) based on the sharp polyphase resolution scaling filter (e.g., A_{φ}[k]) determined at block 605 and a blur filter kernel (e.g., B[k]), as described above. At block 615, if applicable, the hybrid filter generation circuitry 545 of the blur-enabled resolution scaling circuitry 170 generates a hybrid transition polyphase filter (e.g., H₂_{_{φ}}[k]) based on the sharp polyphase resolution scaling filter (e.g., A_{φ}[k]) determined at block 605 and a transition filter kernel (e.g., T[k]), as described above.

At block 620, the blur-enabled resolution scaling circuitry 170 begins processing iterations to generate the output pixels 215 to be included in the scaled output frame 180. For example, at block 625, the source pixel selection circuitry 505 of the blur-enabled resolution scaling circuitry 170 selects, as described above, a group of source pixels 210 (and a sub-pixel phase, if appropriate) to contribute to the current output pixel 215 being generated. At block 630, the segmentation metric calculation circuitry 510 and the pixel classifier circuitry 515 of the blur-enabled resolution scaling circuitry 170 operate to classify the current output pixel based on alpha channel region segmentation values for the selected source pixels to determine a region classification for the output pixel, as described above.

At block 635, the resolution scaling filter selection circuitry 530 of the blur-enabled resolution scaling circuitry 170 selects a resolution scaling filter (e.g., f_{φ}[k]) from among the sharp polyphase resolution scaling filter (e.g., A_{φ}[k]) and the hybrid blur polyphase filter (e.g., H_{φ}[k]) (and/or the hybrid transition polyphase filter (e.g., H₂_{_{φ}}[k]), if applicable) based on the region classification for the output pixel, as described above. At block 640, the pixel filtering circuitry 520 of the blur-enabled resolution scaling circuitry 170 filters the selected source pixels 210 based on the selected resolution scaling filter (e.g., f_{φ}[k]) to determine the current output pixel 215.

At block 645, the blur-enabled resolution scaling circuitry 170 continues processing to generate the output pixels 215 to be included in the scaled output frame 180. After all output pixels 215 have been generated, at block 650, the output frame packing circuitry 525 of the blur-enabled resolution scaling circuitry 170 packs and buffers an output frame 180 including the determined output pixels 215, as described above. The example machine-readable instructions and/or the example operations 600 then end.

FIG. 7 is a flowchart representative of example machine-readable instructions and/or example operations 610 that may be executed, instantiated, and/or performed by programmable circuitry to perform the processing at block 610 of FIG. 6. The example machine-readable instructions and/or the example operations 610 of FIG. 7 begin at block 705, at which the hybrid filter generation circuitry 545 of the blur-enabled resolution scaling circuitry 170 obtains the blur filter kernel (e.g., B[k]) (and transition filter kernel (e.g., T[k]), if applicable), as described above. At block 710, the hybrid filter generation circuitry 545 obtains filter fusion type to be used to generate the hybrid filter(s) to be used by the blur-enabled resolution scaling circuitry 170, as described above.

If the filter fusion type corresponds to average filter fusion, at block 715, the hybrid filter generation circuitry 545 performs average blur filter fusion based on Equation 10 to average the filter coefficients (e.g., the tap weights) of the sharp resolution scaling filter (e.g., A_{φ}[k]) with corresponding tap weights of the blur filter kernel (e.g., B[k]) to generate the hybrid blur resolution scaling filter (e.g., H_{φ}[k]), as described above. At block 720, if applicable, the hybrid filter generation circuitry 545 performs average transition filter fusion based on Equation 11 to average the filter coefficients (e.g., the tap weights) of the sharp resolution scaling filter (e.g., A_{φ}[k]) with corresponding tap weights of the transition filter kernel, represented by (e.g., T[k]), to generate the hybrid blur resolution scaling filter (e.g., H₂_{_{φ}}[k]), as described above.

If the filter fusion type corresponds to weighted average filter fusion, at block 725, the hybrid filter generation circuitry 545 performs programmable weighted blur filter fusion based on Equation 12 to perform a weighted averaging of the filter coefficients (e.g., the tap weights) of the sharp resolution scaling filter (e.g., A_{φ}[k]) with corresponding tap weights of the blur filter kernel (e.g., B[k]), based on a blend factor (e.g., λ), to generate the hybrid blur resolution scaling filter (e.g., H_{φ}[k]), as described above. At block 730, if applicable, the hybrid filter generation circuitry 545 performs programmable weighted transition filter fusion based on Equation 13 to perform a weighted averaging of the filter coefficients (e.g., the tap weights) of the sharp resolution scaling filter (e.g., A_{φ}[k]) with corresponding tap weights of the transition filter kernel (e.g., T[k]), based on a blend factor (e.g., λ), to generate the hybrid transition resolution scaling filter (e.g., H₂_{_{φ}}[k]), as described above.

If the filter fusion type corresponds to nonlinear filter fusion, at block 735 the hybrid filter generation circuitry 545 performs nonlinear blur filter fusion according to Equation 14 to perform a nonlinear combination (e.g., a nonlinear selection) between ones of the filter coefficients (e.g., the tap weights) of the sharp resolution scaling filter (e.g., A_{φ}[k]) and corresponding ones of the filter coefficients (e.g., the tap weights) of the blur filter kernel (e.g., B[k]) to generate the hybrid blur resolution scaling filter (e.g., H_{φ}[k]), as described above. At block 740, if applicable, the hybrid filter generation circuitry 545 performs nonlinear transition filter fusion according to Equation 15 to perform a nonlinear combination (e.g., a nonlinear selection) between ones of the filter coefficients (e.g., the tap weights) of the sharp resolution scaling filter (e.g., A_{φ}[k]) and corresponding ones of the filter coefficients (e.g., the tap weights) of the transition filter kernel (e.g., T[k]) to generate the hybrid transition resolution scaling filter (e.g., H₂_{_{φ}}[k]), as described above.

At block 745, the hybrid filter generation circuitry 545 stores the generated hybrid blur filter (e.g., H_{φ}[k]) (and the generated hybrid transition filter (e.g., H₂_{_{φ}}[k]), if applicable) in the scaling filter data storage 535, as described above. The example machine-readable instructions and/or the example operations 610 then end.

FIG. 8 is a flowchart representative of example machine-readable instructions and/or example operations 630 that may be executed, instantiated, and/or performed by programmable circuitry to perform the processing at block 630 of FIG. 6. The example machine-readable instructions and/or the example operations 630 of FIG. 8 begin at block 805, at which the segmentation metric calculation circuitry 510 of the blur-enabled resolution scaling circuitry 170 obtains alpha channel region segmentation values for the source pixels 210 to contribute to the output pixel 215, as described above. At block 810, the segmentation metric calculation circuitry 510 sums the non-zero sharp filter tap weights (e.g., A_{φ}[k]), which are to be multiplied by the source pixels 210 to produce the output pixel 215, to determine a segmentation metric denominator value (e.g., Wₛᵤₘ) according to Equation 3, as described above. At block 815, the segmentation metric calculation circuitry 510 identifies the source pixel values 210 having alpha channel region segmentation values that satisfy a segmentation threshold (e.g., AlphaMin), as described above. At block 820, the segmentation metric calculation circuitry 510 sums the non-zero sharp filter tap weights (e.g., A_{φ}[k]), which are to be multiplied by the identified source pixels 210 that have alpha channel region segmentation values that satisfy the segmentation threshold (e.g., pixels k with α_{src}[k]>AlphaMin), to determine a segmentation metric numerator value (e.g., W_{cov}) according to Equation 4, as described above. At block 825, the segmentation metric calculation circuitry 510 divides the segmentation metric numerator value (e.g., W_{cov}) by the segmentation metric denominator value (e.g., Wₛᵤₘ) according to Equation 5 to determine the segmentation metric (e.g., C_{α}) for the current output pixel 215 being generated, as described above.

At block 830, the pixel classifier circuitry 515 of the blur-enabled resolution scaling circuitry 170 classifies the current output pixel 215 as a sharp region pixel or a blur region pixel (or a transition region pixel, if applicable) based on comparison of the segmentation metric (e.g., C_{α}) to one or more region thresholds (e.g., RegionThresh_{Sharp}, RegionThresh_{Blur}) according to Equation 6, as described above. The example machine-readable instructions and/or the example operations 630 then end.

FIG. 9 is a flowchart representative of example machine-readable instructions and/or example operations 635 that may be executed, instantiated, and/or performed by programmable circuitry to perform the processing at block 635 of FIG. 6. The example machine-readable instructions and/or the example operations 635 of FIG. 9 begin at block 905, at which the resolution scaling filter selection circuitry 530 of the blur-enabled resolution scaling circuitry 170 obtains the region classification (e.g., RegionClass_{OUT}) for the current output pixel 215 being generated. If the region classification (e.g., RegionClass_{OUT}) corresponds to a sharp pixel region, at block 910 the resolution scaling filter selection circuitry 530 selects the resolution scaling filter (e.g., f_{φ}[k]) to be the sharp filter( ), as described above. However, if the region classification (e.g., RegionClass_{OUT}) corresponds to a blur pixel region, at block 915 the resolution scaling filter selection circuitry 530 selects the resolution scaling filter (e.g., f_{φ}[k]) to be the hybrid blur filter (e.g., H_{φ}[k]), as described above. However, if the region classification (e.g., RegionClass_{OUT}) corresponds to a transition pixel region, at block 920 the resolution scaling filter selection circuitry 530 selects the resolution scaling filter (e.g., f_{φ}[k]) to be the hybrid transition filter (e.g., H₂_{_{φ}}[k]), as described above.

At block 925, the resolution scaling filter selection circuitry 530 configures the pixel filtering circuitry 520 of the blur-enabled resolution scaling circuitry 170 to access the selected resolution scaling filter for processing the current output pixel 215, as described above. The example machine-readable instructions and/or the example operations 635 then end.

FIG. 10 is a block diagram of an example programmable circuitry platform 1000 structured to execute and/or instantiate the example machine-readable instructions and/or the example operations of FIGS. 6-9 to implement the blur-enabled resolution scaling circuitry 170 of FIG. 5. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements one or more of the example source pixel selection circuitry 505, the example segmentation metric calculation circuitry 510, the example pixel classifier circuitry 515, the example pixel filtering circuitry 520, the example output frame packing circuitry 525, the example resolution scaling filter selection circuitry 530, the example sharp filter generation circuitry 540, the example hybrid filter generation circuitry 545 and/or, more generally, the blur-enabled resolution scaling circuitry 170.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016. In some examples, the memory 1014 and/or 1016 implement the example scaling filter data storage 535 and/or the example configuration data storage 550 of the blur-enabled resolution scaling circuitry 170.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs and/or devices 1028 to store firmware, software, and/or data. Examples of such mass storage discs and/or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the storage discs and/or devices 1028 implement the example scaling filter data storage 535 and/or the example configuration data storage 550 of the blur-enabled resolution scaling circuitry 170.

The machine-readable instructions 1032, which may be implemented by the machine-readable instructions of FIGS. 6-9, may be stored in the mass storage device 1028, in the volatile memory 1014, in the non-volatile memory 1016, and/or on at least one non-transitory computer-readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 6-9 to effectively instantiate the circuitry of FIG. 5 as logic circuits to perform operations corresponding to those machine-readable instructions. In some such examples, the circuitry of FIG. 5 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine-readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine-readable instructions and/or operations represented by the flowcharts of FIGS. 6-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine-readable instructions. However, once configured, the FPGA circuitry 1200 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine-readable instructions represented by the flowchart(s) of FIGS. 6-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-9. As such, the FPGA circuitry 1200 may be configured and/or structured to effectively instantiate some or all of the operations/functions corresponding to the machine-readable instructions of the flowchart(s) of FIGS. 6-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine-readable instructions of FIGS. 6-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine-readable instructions of FIGS. 6-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine-readable instructions represented by the flowchart(s) of FIGS. 6-9 to perform first operation(s)/function(s), the FPGA circuitry 1200 of FIG. 12 may be configured and/or structured to perform second operation(s)/function(s) corresponding to a second portion of the machine-readable instructions represented by the flowcharts of FIG. 6-9, and/or an ASIC may be configured and/or structured to perform third operation(s)/function(s) corresponding to a third portion of the machine-readable instructions represented by the flowcharts of FIGS. 6-9.

It should be understood that some or all of the circuitry of FIG. 5 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 1100 of FIG. 11 may execute machine-readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 5 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

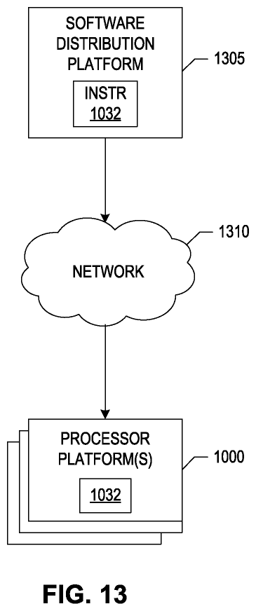

A block diagram illustrating an example software distribution platform 1305 to distribute software such as the example machine-readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine-readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine-readable instructions of FIGS. 6-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1032 from the software distribution platform 1305. For example, the software, which may correspond to the example machine-readable instructions of FIG. 6-9, may be downloaded to the example programmable circuitry platform 1000, which is to execute the machine-readable instructions 1032 to implement the blur-enabled resolution scaling circuitry 170. In some examples, one or more servers of the software distribution platform 1305 periodically offer, transmit, and/or force updates to the software (e.g., the example machine-readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement frame resolution scaling with region blurring. Disclosed systems, apparatus, articles of manufacture, and methods improve the efficiency of using a computing device by integrating selective region blurring capability with frame resolution scaling in a single processing pass. In some examples, blur-enabled resolution scaling circuitry disclosed herein provides a per-pixel, alpha-driven tap selection mechanism that enables region selective blurring to be integrated into the same filter used for frame resolution scaling. Because the same resolution scaling filter structure is used to perform both resolution scaling and region-specific blurring, example blur-enabled resolution scaling circuitry disclosed herein eliminates the need for separate resolution scaling and blur processing passes, thereby delivering memory bandwidth and power consumption savings relative to conventional privacy-enabled video pipelines, and enabling real-time background obfuscation at any resolution without performance degradation. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus to comprising interface circuitry, machine-readable instructions, and at least one programmable circuit to be programmed based on the machine-readable instructions to determine a region classification associated with an output pixel of an output frame based on alpha channel values of source pixels of a source frame, the alpha channel values based on segmentation of the source frame to identify a region to be blurred, select a resolution scaling filter from a set of resolution scaling filters based on the region classification, and cause filter circuitry to apply the selected resolution scaling filter to the source pixels to generate the output pixel.

Example 2 includes the apparatus of example 1, wherein the region classification is to classify the output pixel into one of a plurality of pixel regions, the pixel regions including a sharp pixel region and a blur pixel region, and one or more of the at least one programmable circuit is to select a first resolution scaling filter of the set of resolution scaling filters to be the selected resolution scaling filter based on the region classification corresponding to the sharp pixel region, and select a second resolution scaling filter of the set of resolution scaling filters to be the selected resolution scaling filter based on the region classification corresponding to the blur pixel region.

Example 3 includes the apparatus of example 2, wherein the pixel regions include a transition pixel region, and one or more of the at least one programmable circuit is to select a third resolution scaling filter of the set of resolution scaling filters to be the selected resolution scaling filter based on the region classification corresponding to the transition pixel region.

Example 4 includes the apparatus of example 3, wherein one or more of the at least one programmable circuit is to generate the first resolution scaling filter based on a source resolution associated with the source frame and an output resolution associated with the output frame, generate the second resolution scaling filter based on the first resolution scaling filter and a blur filter kernel, and. generate the third resolution scaling filter based on the first resolution scaling filter and a transition filter kernel.

Example 5 includes the apparatus of example 2, wherein one or more of the at least one programmable circuit is to generate the first resolution scaling filter based on a source resolution associated with the source frame and an output resolution associated with the output frame, and generate the second resolution scaling filter based on the first resolution scaling filter and a blur filter kernel.

Example 6 includes the apparatus of example 5, wherein one or more of the at least one programmable circuit is to average tap weights of the first resolution scaling filter with corresponding tap weights of the blur filter kernel to generate the second resolution scaling filter.

Example 7 includes the apparatus of example 5, wherein one or more of the at least one programmable circuit is to perform a weighted average of tap weights of the first resolution scaling filter with corresponding tap weights of the blur filter kernel based on a blend factor to generate the second resolution scaling filter.

Example 8 includes the apparatus of example 5, wherein one or more of the at least one programmable circuit is to generate the second resolution scaling filter based on a nonlinear combination of tap weights of the first resolution scaling filter and corresponding tap weights of the blur filter kernel.

Example 9 includes the apparatus of any one of examples 2 to 8, wherein one or more of the at least one programmable circuit is to determine a segmentation metric based on the alpha channel values of a group of the source pixels that contribute to generation of the output pixel, and determine the region classification associated with the output pixel based on the segmentation metric and at least one region threshold.

Example 10 includes the apparatus of example 9, wherein one or more of the at least one programmable circuit is to determine the region classification corresponds to the sharp pixel region based on the segmentation metric satisfying the at least one region threshold, and determine the region classification corresponds to the blur pixel region based on the segmentation metric not satisfying the at least one region threshold.

Example 11 includes the apparatus of example 9, wherein the pixel regions include a transition pixel region, the at least one region threshold includes a first region threshold and a second region threshold, and one or more of the at least one programmable circuit is to determine the region classification corresponds to the sharp pixel region based on the segmentation metric satisfying the first region threshold, determine the region classification corresponds to the blur pixel region based on the segmentation metric not satisfying the second region threshold, and determine the region classification corresponds to the transition pixel region based on the segmentation metric not satisfying first region threshold but satisfying the second region threshold.

Example 12 includes the apparatus of any one of examples 9 to 11, wherein one or more of the at least one programmable circuit is to determine a first sum of tap weights of the first resolution scaling filter, determine a second sum of ones of the tap weights of the first resolution scaling filter that are to scale corresponding ones of the source pixels having alpha channel values that satisfy a segmentation threshold, and determine the segmentation metric based on a ratio, the ratio based on the first sum and the second sum.

Example 13 includes the apparatus of any one of examples 2 to 8, wherein one or more of the at least one programmable circuit is to fetch ones of the alpha channel values based on tap footprint and phase positions corresponding to color channels of a group of the source pixels that contribute to generation of the output pixel, determine a segmentation metric based on the fetched ones of the alpha channel values, and determine the region classification associated with the output pixel based on the segmentation metric and at least one region threshold.

Example 14 includes at least one non-transitory machine-readable storage medium comprising machine-readable instructions to cause at least one programmable circuit to at least classify an output pixel of an output frame into a pixel region based on alpha channel values of source pixels of a source frame, the alpha channel values to indicate a region of the source frame to be blurred. select a resolution scaling filter based on the pixel region into which the output pixel is classified, and cause filter circuitry to apply the selected resolution scaling filter to at least some of the source pixels to generate the output pixel.

Example 15 includes the at least one non-transitory machine-readable storage medium of example 14, wherein the pixel region is one of a plurality of pixel regions including a sharp pixel region, a blur pixel region and a transition pixel region, and the machine-readable instructions are to cause one or more of the at least one programmable circuit to select the resolution scaling filter by one of selecting a first resolution scaling filter to be the selected resolution scaling filter based on the output pixel being classified into the sharp pixel region, selecting a second resolution scaling filter to be the selected resolution scaling filter based on the output pixel being classified into the blur pixel region, or selecting a third resolution scaling filter to be the selected resolution scaling filter based on the output pixel being classified into the transition pixel region.

Example 16 includes the at least one non-transitory machine-readable storage medium of example 15, wherein the machine-readable instructions are to cause one or more of the at least one programmable circuit to at least one of generate the first resolution scaling filter based on a source resolution associated with the source frame and an output resolution associated with the output frame, generate the second resolution scaling filter based on the first resolution scaling filter and a blur filter kernel, or generate the third resolution scaling filter based on the first resolution scaling filter and a transition filter kernel.

Example 17 includes the at least one non-transitory machine-readable storage medium of example 15 or example 16, wherein the machine-readable instructions are to cause one or more of the at least one programmable circuit to determine a denominator value based on a sum of tap weights of the first resolution scaling filter, determine a numerator value based on a sum of ones of the tap weights of the first resolution scaling filter that are to scale corresponding ones of the source pixels having alpha channel values that satisfy a segmentation threshold, determine a segmentation metric based on a ratio of the numerator value to the denominator value, and classify the output pixel into the pixel region based on the segmentation metric and at least one region threshold.

Example 18 includes the at least one non-transitory machine-readable storage medium of any one of examples 14 to 17, wherein the machine-readable instructions are to cause one or more of the at least one programmable circuit to fetch ones of the alpha channel values based on tap footprint and phase positions corresponding to color channels of a group of the source pixels that contribute to generation of the output pixel, determine a segmentation metric based on the fetched ones of the alpha channel values, and classify the output pixel into the pixel region based on the segmentation metric and at least one region threshold.

Example 19 includes a system comprising means for classifying an output pixel of an output frame into a pixel region based on alpha channel values of source pixels of a source frame, the alpha channel values based on segmentation of the source frame to identify a region to be blurred. means for selecting a resolution scaling filter based on the pixel region into which the output pixel is classified, and means for filtering at least some of the source pixels based on the selected resolution scaling filter to generate the output pixel.

Example 20 includes the system of example 19, wherein the pixel region is one of a plurality of pixel regions including a sharp pixel region, a blur pixel region and a transition pixel region, and the means for selecting the resolution scaling filter is to select the resolution scaling filter by one of selecting a first resolution scaling filter to be the selected resolution scaling filter based on the output pixel being classified into the sharp pixel region, selecting a second resolution scaling filter to be the selected resolution scaling filter based on the output pixel being classified into the blur pixel region, or selecting a third resolution scaling filter to be the selected resolution scaling filter based on the output pixel being classified into the transition pixel region.

Example 21 includes the system of example 20, including means for generating resource scaling filters, the means for generating resource scaling filters to at least one of generate the first resolution scaling filter based on a source resolution associated with the source frame and an output resolution associated with the output frame, generate the second resolution scaling filter based on the first resolution scaling filter and a blur filter kernel, or generate the third resolution scaling filter based on the first resolution scaling filter and a transition filter kernel.

Example 22 includes the system of example 20 or example 21, wherein the means for classifying the output pixel is to determine a denominator value based on a sum of tap weights of the first resolution scaling filter, determine a numerator value based on a sum of ones of the tap weights of the first resolution scaling filter that are to scale corresponding ones of the source pixels having alpha channel values that satisfy a segmentation threshold, determine a segmentation metric based on a ratio of the numerator value to the denominator value, and classify the output pixel into the pixel region based on the segmentation metric and at least one region threshold.

Example 23 includes a method comprising determining a region classification associated with an output pixel of an output frame based on alpha channel values of source pixels of a source frame, the alpha channel values based on segmentation of the source frame to identify a region to be blurred, selecting a resolution scaling filter from a set of resolution scaling filters based on the region classification, and causing filter circuitry to apply the selected resolution scaling filter to the source pixels to generate the output pixel.

Example 24 includes the method of example 23, wherein the region classification is to classify the output pixel into one of a plurality of pixel regions, the pixel regions including a sharp pixel region and a blur pixel region, and the selecting of the resolution scaling filter includes selecting a first resolution scaling filter of the set of resolution scaling filters to be the selected resolution scaling filter based on the region classification corresponding to the sharp pixel region, and selecting a second resolution scaling filter of the set of resolution scaling filters to be the selected resolution scaling filter based on the region classification corresponding to the blur pixel region.

Example 25 includes the method of example 24, wherein the pixel regions include a transition pixel region, and the selecting of the resolution scaling filter includes selecting a third resolution scaling filter of the set of resolution scaling filters to be the selected resolution scaling filter based on the region classification corresponding to the transition pixel region.

Example 26 includes the method of example 25, including generating the first resolution scaling filter based on a source resolution associated with the source frame and an output resolution associated with the output frame, generating the second resolution scaling filter based on the first resolution scaling filter and a blur filter kernel, and. generating the third resolution scaling filter based on the first resolution scaling filter and a transition filter kernel.

Example 27 includes the method of example 24, including generating the first resolution scaling filter based on a source resolution associated with the source frame and an output resolution associated with the output frame, and generating the second resolution scaling filter based on the first resolution scaling filter and a blur filter kernel.

Example 28 includes the method of example 27, wherein the generating of the second resolution scaling filter includes averaging tap weights of the first resolution scaling filter with corresponding tap weights of the blur filter kernel to generate the second resolution scaling filter.

Example 29 includes the method of example 27, wherein the generating of the second resolution scaling filter includes performing a weighted average of tap weights of the first resolution scaling filter with corresponding tap weights of the blur filter kernel based on a blend factor to generate the second resolution scaling filter.

Example 30 includes the method of example 27, wherein the generating of the second resolution scaling filter is based on a nonlinear combination of tap weights of the first resolution scaling filter and corresponding tap weights of the blur filter kernel.

Example 31 includes the method of any one of examples 24 to 30, wherein the determining of the region classification includes determining a segmentation metric based on the alpha channel values of a group of the source pixels that contribute to generation of the output pixel, and determining the region classification associated with the output pixel based on the segmentation metric and at least one region threshold.

Example 32 includes the method of example 31, wherein the determining of the region classification includes determining the region classification corresponds to the sharp pixel region based on the segmentation metric satisfying the at least one region threshold, and determining the region classification corresponds to the blur pixel region based on the segmentation metric not satisfying the at least one region threshold.

Example 33 includes the method of example 31, wherein the pixel regions include a transition pixel region, the at least one region threshold includes a first region threshold and a second region threshold, and the determining of the region classification includes determining the region classification corresponds to the sharp pixel region based on the segmentation metric satisfying the first region threshold, determining the region classification corresponds to the blur pixel region based on the segmentation metric not satisfying the second region threshold, and determine the region classification corresponds to the transition pixel region based on the segmentation metric not satisfying first region threshold but satisfying the second region threshold.

Example 34 includes the method of any one of examples 31 to 33, wherein the determining of the segmentation metric includes determining a first sum of tap weights of the first resolution scaling filter, determining a second sum of ones of the tap weights of the first resolution scaling filter that are to scale corresponding ones of the source pixels having alpha channel values that satisfy a segmentation threshold, and determining the segmentation metric based on a ratio, the ratio based on the first sum and the second sum.

Example 35 includes the method of any one of examples 24 to 30, wherein the determining of the region classification includes fetching ones of the alpha channel values based on tap footprint and phase positions corresponding to color channels of a group of the source pixels that contribute to generation of the output pixel, determining a segmentation metric based on the fetched ones of the alpha channel values, and determining the region classification associated with the output pixel based on the segmentation metric and at least one region threshold.

Example 36 includes at least one machine-readable medium comprising machine-readable instructions to cause at least one programmable circuit to perform the method of any one of examples 23 to example 35.

Example 37 includes an apparatus to perform the method of any one of examples 23 to example 35.

Example 38 includes a method performed by any one of the apparatus of examples 1 to example 13.

Example 39 includes at least one machine-readable medium comprising the machine-readable instructions of any one of the apparatus of examples 1 to example 13.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus to comprising:
interface circuitry;
machine-readable instructions; and
at least one programmable circuit to be programmed based on the machine-readable instructions to:
determine a region classification associated with an output pixel of an output frame based on alpha channel values of source pixels of a source frame, the alpha channel values based on segmentation of the source frame to identify a region to be blurred;
select a resolution scaling filter from a set of resolution scaling filters based on the region classification; and
cause filter circuitry to apply the selected resolution scaling filter to the source pixels to generate the output pixel.

2. The apparatus of claim 1, wherein the region classification is to classify the output pixel into one of a plurality of pixel regions, the pixel regions including a sharp pixel region and a blur pixel region, and one or more of the at least one programmable circuit is to:
select a first resolution scaling filter of the set of resolution scaling filters to be the selected resolution scaling filter based on the region classification corresponding to the sharp pixel region; and
select a second resolution scaling filter of the set of resolution scaling filters to be the selected resolution scaling filter based on the region classification corresponding to the blur pixel region.

3. The apparatus of claim 2, wherein the pixel regions include a transition pixel region, and one or more of the at least one programmable circuit is to select a third resolution scaling filter of the set of resolution scaling filters to be the selected resolution scaling filter based on the region classification corresponding to the transition pixel region.

4. The apparatus of claim 3, wherein one or more of the at least one programmable circuit is to:
generate the first resolution scaling filter based on a source resolution associated with the source frame and an output resolution associated with the output frame;
generate the second resolution scaling filter based on the first resolution scaling filter and a blur filter kernel; and
generate the third resolution scaling filter based on the first resolution scaling filter and a transition filter kernel.

5. The apparatus of claim 2, wherein one or more of the at least one programmable circuit is to:
generate the first resolution scaling filter based on a source resolution associated with the source frame and an output resolution associated with the output frame; and
generate the second resolution scaling filter based on the first resolution scaling filter and a blur filter kernel.

6. The apparatus of claim 5, wherein one or more of the at least one programmable circuit is to average tap weights of the first resolution scaling filter with corresponding tap weights of the blur filter kernel to generate the second resolution scaling filter.

7. The apparatus of claim 5, wherein one or more of the at least one programmable circuit is to perform a weighted average of tap weights of the first resolution scaling filter with corresponding tap weights of the blur filter kernel based on a blend factor to generate the second resolution scaling filter.

8. The apparatus of claim 5, wherein one or more of the at least one programmable circuit is to generate the second resolution scaling filter based on a nonlinear combination of tap weights of the first resolution scaling filter and corresponding tap weights of the blur filter kernel.

9. The apparatus of claim 2, wherein one or more of the at least one programmable circuit is to:
determine a segmentation metric based on the alpha channel values of a group of the source pixels that contribute to generation of the output pixel; and
determine the region classification associated with the output pixel based on the segmentation metric and at least one region threshold.

10. The apparatus of claim 9, wherein one or more of the at least one programmable circuit is to:
determine the region classification corresponds to the sharp pixel region based on the segmentation metric satisfying the at least one region threshold; and
determine the region classification corresponds to the blur pixel region based on the segmentation metric not satisfying the at least one region threshold.

11. The apparatus of claim 9, wherein the pixel regions include a transition pixel region, the at least one region threshold includes a first region threshold and a second region threshold, and one or more of the at least one programmable circuit is to:
determine the region classification corresponds to the sharp pixel region based on the segmentation metric satisfying the first region threshold;
determine the region classification corresponds to the blur pixel region based on the segmentation metric not satisfying the second region threshold; and
determine the region classification corresponds to the transition pixel region based on the segmentation metric not satisfying first region threshold but satisfying the second region threshold.

12. The apparatus of claim 9, wherein one or more of the at least one programmable circuit is to:
determine a first sum of tap weights of the first resolution scaling filter;
determine a second sum of ones of the tap weights of the first resolution scaling filter that are to scale corresponding ones of the source pixels having alpha channel values that satisfy a segmentation threshold; and
determine the segmentation metric based on a ratio, the ratio based on the first sum and the second sum.

13. The apparatus of claim 2, wherein one or more of the at least one programmable circuit is to:
fetch ones of the alpha channel values based on tap footprint and phase positions corresponding to color channels of a group of the source pixels that contribute to generation of the output pixel;
determine a segmentation metric based on the fetched ones of the alpha channel values; and
determine the region classification associated with the output pixel based on the segmentation metric and at least one region threshold.

14. At least one non-transitory machine-readable storage medium comprising machine-readable instructions to cause at least one programmable circuit to at least:
classify an output pixel of an output frame into a pixel region based on alpha channel values of source pixels of a source frame, the alpha channel values to indicate a region of the source frame to be blurred;
select a resolution scaling filter based on the pixel region into which the output pixel is classified; and
cause filter circuitry to apply the selected resolution scaling filter to at least some of the source pixels to generate the output pixel.

15. The at least one non-transitory machine-readable storage medium of claim 14, wherein the pixel region is one of a plurality of pixel regions including a sharp pixel region, a blur pixel region and a transition pixel region, and the machine-readable instructions are to cause one or more of the at least one programmable circuit to select the resolution scaling filter by one of:
selecting a first resolution scaling filter to be the selected resolution scaling filter based on the output pixel being classified into the sharp pixel region;
selecting a second resolution scaling filter to be the selected resolution scaling filter based on the output pixel being classified into the blur pixel region; or
selecting a third resolution scaling filter to be the selected resolution scaling filter based on the output pixel being classified into the transition pixel region.

16. The at least one non-transitory machine-readable storage medium of claim 15, wherein the machine-readable instructions are to cause one or more of the at least one programmable circuit to at least one of:
generate the first resolution scaling filter based on a source resolution associated with the source frame and an output resolution associated with the output frame;
generate the second resolution scaling filter based on the first resolution scaling filter and a blur filter kernel; or
generate the third resolution scaling filter based on the first resolution scaling filter and a transition filter kernel.

17. The at least one non-transitory machine-readable storage medium of claim 15, wherein the machine-readable instructions are to cause one or more of the at least one programmable circuit to:
determine a denominator value based on a sum of tap weights of the first resolution scaling filter;
determine a numerator value based on a sum of ones of the tap weights of the first resolution scaling filter that are to scale corresponding ones of the source pixels having alpha channel values that satisfy a segmentation threshold;
determine a segmentation metric based on a ratio of the numerator value to the denominator value; and
classify the output pixel into the pixel region based on the segmentation metric and at least one region threshold.

18. The at least one non-transitory machine-readable storage medium of claim 14, wherein the machine-readable instructions are to cause one or more of the at least one programmable circuit to:
fetch ones of the alpha channel values based on tap footprint and phase positions corresponding to color channels of a group of the source pixels that contribute to generation of the output pixel;
determine a segmentation metric based on the fetched ones of the alpha channel values; and
classify the output pixel into the pixel region based on the segmentation metric and at least one region threshold.

19. A system comprising:
means for classifying an output pixel of an output frame into a pixel region based on alpha channel values of source pixels of a source frame, the alpha channel values based on segmentation of the source frame to identify a region to be blurred;
means for selecting a resolution scaling filter based on the pixel region into which the output pixel is classified; and
means for filtering at least some of the source pixels based on the selected resolution scaling filter to generate the output pixel.

20. The system of claim 19, wherein the pixel region is one of a plurality of pixel regions including a sharp pixel region, a blur pixel region and a transition pixel region, and the means for selecting the resolution scaling filter is to select the resolution scaling filter by one of:
selecting a first resolution scaling filter to be the selected resolution scaling filter based on the output pixel being classified into the sharp pixel region;
selecting a second resolution scaling filter to be the selected resolution scaling filter based on the output pixel being classified into the blur pixel region; or
selecting a third resolution scaling filter to be the selected resolution scaling filter based on the output pixel being classified into the transition pixel region.
